(19) United States
(12) Patent Application Publication
(10) Pub. No.: US 2026/0231068 A1
(43) Pub. Date: Aug. 6, 2026

(54) NARROWBAND UPLINK COMMUNICATION TIME BASED ON ORTHOGONAL COVER CODE MULTIPLEXING FACTOR

(71) Applicant: QUALCOMM Incorporated, San Diego, CA (US)

(72) Inventors: Syed Hashim Ali SHAH, Littleton, MA (US); Ayan SENGUPTA, Mountain View, CA (US); Alberto RICO ALVARINO, San Diego, CA (US)

(21) Appl. No.: 19/410,329

(22) Filed: Dec. 5, 2025

Related U.S. Application Data
(60) Provisional application No. 63/753,891, filed on Feb. 4, 2025.

(51) Int. Cl. H04W 56/00; H04L 5/00

(52) U.S. Cl. CPC H04W 56/002; H04L 5/0016

(57) ABSTRACT

Various aspects of the present disclosure generally relate to wireless communication. Some aspects more specifically relate to constraining transmission times for narrowband physical uplink shared channel (NPUSCH) communications in accordance with an orthogonal cover code (OCC) multiplexing factor. In some aspects, a network node may configure a user equipment (UE) with the OCC multiplexing factor, and the UE may transmit an NPUSCH communication at a time that depends on the OCC multiplexing factor.

### CROSS-REFERENCE TO RELATED APPLICATION

This patent application claims priority to U.S. Provisional Patent Application No. 63/753,891, filed on Feb. 4, 2025, entitled “NARROWBAND UPLINK COMMUNICATION TIME BASED ON ORTHOGONAL COVER CODE MULTIPLEXING FACTOR,” and assigned to the assignee hereof. The disclosure of the prior application is considered part of and is incorporated by reference into this patent application.

### FIELD OF THE DISCLOSURE

Aspects of the present disclosure generally relate to wireless communication and specifically relate to techniques, apparatuses, and methods associated with narrowband uplink communication times in accordance with an orthogonal cover code multiplexing factor.

### BACKGROUND

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, or radio frequency (RF) sensing, among other examples.

Orthogonal cover codes (OCCs) allow user equipments (UEs) in multiple access schemes to multiplex signals orthogonally, which can reduce interference at a network node. In some examples, OCC may be used in narrowband physical uplink shared channel (NPUSCH) communications for narrowband internet of things (IoT) (NB-IoT) non-terrestrial networks (NTNs). Generally, the NPUSCH communication can start in any arbitrary NB-IoT uplink slot. However, certain choices of NB-IoT uplink slot can lead to misalignments between the UEs, such as misalignments in OCC codewords or demodulation reference signal (DMRS) patterns. These misalignments can reduce performance or capacity in NB-IoT NTN systems.

### SUMMARY

Some aspects described herein relate to an apparatus for wireless communication at a user equipment (UE). The apparatus may include one or more memories and one or more processors coupled to the one or more memories. The one or more processors may be individually or collectively configured to cause the UE to transmit a UE capability indication associated with multiplexing. The one or more processors may be individually or collectively configured to cause the UE to receive, in accordance with the UE capability indication, an indication of an orthogonal cover code (OCC) multiplexing factor. The one or more processors may be individually or collectively configured to cause the UE to transmit a narrowband uplink communication at a time in accordance with the OCC multiplexing factor.

Some aspects described herein relate to an apparatus for wireless communication at a network node. The apparatus may include one or more memories and one or more processors coupled to the one or more memories. The one or more processors may be individually or collectively configured to cause the network node to receive a UE capability indication associated with multiplexing. The one or more processors may be individually or collectively configured to cause the network node to transmit, in accordance with the UE capability indication, an indication of an OCC multiplexing factor. The one or more processors may be individually or collectively configured to cause the network node to receive a narrowband uplink communication at a time in accordance with the OCC multiplexing factor.

Some aspects described herein relate to a method of wireless communication performed at a UE. The method may include transmitting a UE capability indication associated with multiplexing. The method may include receiving, in accordance with the UE capability indication, an indication of an OCC multiplexing factor. The method may include transmitting a narrowband uplink communication at a time in accordance with the OCC multiplexing factor.

Some aspects described herein relate to a method of wireless communication performed by a network node. The method may include receiving a UE capability indication associated with multiplexing. The method may include transmitting, in accordance with the UE capability indication, an indication of an OCC multiplexing factor. The method may include receiving a narrowband uplink communication at a time in accordance with the OCC multiplexing factor.

Some aspects described herein relate to an apparatus for wireless communication. The apparatus may include means for transmitting an apparatus capability indication associated with multiplexing. The apparatus may include means for receiving, in accordance with the UE capability indication, an indication of an OCC multiplexing factor. The apparatus may include means for transmitting a narrowband uplink communication at a time in accordance with the OCC multiplexing factor.

Some aspects described herein relate to an apparatus for wireless communication. The apparatus may include means for receiving a UE capability indication associated with multiplexing. The apparatus may include means for transmitting, in accordance with the UE capability indication, an indication of an OCC multiplexing factor. The apparatus may include means for receiving a narrowband uplink communication at a time in accordance with the OCC multiplexing factor.

Some aspects described herein relate to a non-transitory computer-readable medium storing a set of instructions for wireless communication. The set of instructions may include one or more instructions that, when executed at a UE, cause the UE to transmit a UE capability indication associated with multiplexing. The set of instructions may include one or more instructions that, when executed at the UE, cause the UE to receive, in accordance with the UE capability indication, an indication of an OCC multiplexing factor. The set of instructions may include one or more instructions that, when executed at the UE, cause the UE to transmit a narrowband uplink communication at a time in accordance with the OCC multiplexing factor.

Some aspects described herein relate to a non-transitory computer-readable medium storing a set of instructions for wireless communication. The set of instructions may include one or more instructions that, when executed at a network node, cause the network node to receive a UE capability indication associated with multiplexing. The set of instructions may include one or more instructions that, when executed at the network node, cause the network node to transmit, in accordance with the UE capability indication, an indication of an OCC multiplexing factor. The set of instructions may include one or more instructions that, when executed at the network node, cause the network node to receive a narrowband uplink communication at a time in accordance with the OCC multiplexing factor.

Aspects of the present disclosure may generally be implemented by or as a method, apparatus, system, computer program product, non-transitory computer-readable medium, user equipment, base station, network node, network entity, wireless communication device, or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network.

FIG. 2 is a diagram illustrating an example of orthogonal cover code (OCC).

FIG. 3 is a diagram illustrating an example of time-division multiplexing (TDM) demodulation reference signal (DMRS) patterns in OCC.

FIG. 4 is a diagram illustrating an example of user equipment (UE) procedures for transmitting narrowband physical uplink shared channel (NPUSCH) communications.

FIGS. 5A-5C are diagrams illustrating examples of misalignment in OCC.

FIG. 6 is a diagram illustrating an example associated with signaling for OCC-multiplexing-factor-based narrowband uplink communication times.

FIGS. 7A-7E are diagrams illustrating examples associated with first aspects for OCC-multiplexing-factor-based narrowband uplink communication times.

FIGS. 8A-8C are diagrams illustrating examples associated with second aspects for OCC-multiplexing-factor-based narrowband uplink communication times.

FIGS. 9A-9C are diagrams illustrating examples associated with third aspects for OCC-multiplexing-factor-based narrowband uplink communication times.

FIG. 10 is a flowchart illustrating an example process performed, for example, at a UE or an apparatus of a UE that supports narrowband uplink communication times in accordance with an OCC multiplexing factor.

FIG. 11 is a flowchart illustrating an example process performed, for example, at a network node or an apparatus of a network node that supports narrowband uplink communication times in accordance with an OCC multiplexing factor.

FIG. 12 is a diagram of an example apparatus for wireless communication, such as a UE or an apparatus of a UE, that supports narrowband uplink communication times in accordance with an OCC multiplexing factor.

FIG. 13 is a diagram of an example apparatus for wireless communication, such as a network node or an apparatus of a network node, that supports narrowband uplink communication times in accordance with an OCC multiplexing factor.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures or functionalities in addition to or other than the structures or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A multiple access scheme can increase capacity by multiplexing M (where M>1) user equipments (UEs). For example, the multiple access scheme may increase capacity by increasing a quantity of UEs that can use a given set of time-frequency resources (for example, resource elements (REs)) compared to scenarios where the multiple access scheme is not implemented. However, multiplexing UEs can create interference at a network node.

Accordingly, orthogonal cover codes (OCCs) can be used to mitigate interference resulting from the multiple access scheme. Using OCCs, data to be transmitted by a given one of the multiplexed MUEs is cover-coded across repetitions in an orthogonal manner using an OCC. Due to the repetitive nature of uplink transmissions, wireless communication systems can perform OCC-based multiplexing without increased resource usage (for example, as compared to using a code division multiple access (CDMA) based scheme).

OCC may be applied to narrowband physical uplink shared channel (NPUSCH) communications for narrowband internet of things (IoT) (NB-IoT) non-terrestrial networks (NTNs). In some examples, a narrowband physical downlink control channel (NPDCCH) communication that schedules an NPUSCH communication may end in NB-IoT downlink subframe n, and the NPUSCH communication may start in a NB-IoT uplink slot n₀. For example, the NB-IoT uplink slot n₀ may be a first NB-IoT uplink slot n₀ after the end of subframe n+k₀+K_{offset}, where k₀ and K_{offset} are network-configured parameters.

Thus, the NPUSCH communication may start at any arbitrary NB-IoT uplink slot n₀ that is the first NB-IoT uplink slot n₀ after the end of subframe n+k₀+K_{offset}. However, certain choices of the NB-IoT uplink slot n₀ can cause misalignment with respect to an OCC codeword length or duration (“OCC codeword misalignment”) or a demodulation reference signal (DMRS) pattern (“DMRS pattern misalignment”). OCC codeword misalignment may occur where multiple UEs apply, for the same resource, OCC codewords that are misaligned from each other such that transmitted signals carried in that resource are not orthogonal to each other. DMRS pattern misalignment may occur where multiple UEs transmit respective DMRSs in the same DMRS symbol, or where a DMRS symbol carries no DMRS. OCC codeword misalignment or DMRS pattern misalignment may render NPUSCH communications that are multiplexed using OCC undecodable at the NB-IoT NTN due to interference. As a result, NB-IoT NTN systems using NPUSCH with OCC may lose one or more of performance or capacity.

Various aspects relate generally to constraining NPUSCH communication transmission times. Some aspects more specifically relate to identifying NB-IoT uplink slots n₀ in accordance with a quantity of multiplexed UEs, which may be referred to as an OCC multiplexing factor M. In some examples, a network node (for example, a NB-IoT NTN node) may configure a UE with the OCC multiplexing factor M, and the UE may transmit an NPUSCH communication at a start time (for example, at a NB-IoT uplink slot n₀) that depends on the OCC multiplexing factor M.

In some aspects, the NB-IoT uplink slot n₀ may have a slot index that is equal to a multiple of K×M, or the slot index modulo K×M may be equal to an offset, where K is an integer. The slot index may be an absolute slot number that is calculated in accordance with a system frame number, frame number, or subframe number, among other examples. The value of K may be predefined in a wireless communication standard or network-configured, among other examples. In some examples, K=1 may help to align OCC codewords, and K=2 may help to align DMRS patterns.

In some aspects, the network node may select a value of k₀ in accordance with the OCC multiplexing factor M. The UE may then transmit the NPUSCH communication at NB-IoT uplink slot n₀, which may depend on k₀. In some examples, the network node may select a value of k₀ that translates to a value of n₀ such that one or more of OCC codeword misalignment or DMRS pattern misalignment are avoided. For example, the network node may select a value of k₀ that makes the slot index of the NB-IoT uplink slot n₀ equal to a multiple of M (which may address OCC codeword misalignment) or a multiple of 2M (which may address DMRS pattern misalignment).

In some aspects, the NB-IoT uplink slot n₀ may have a slot index that depends on an alignment offset parameter k_{0-OCC}, which may have any integer value from 0 to K×M−1. For example, the NB-IoT uplink slot n₀ may be the first NB-IoT uplink slot starting after the end of subframe n+k₀+k_{0-OCC}+K_{offset}. In some examples, the network node may select a value of k_{0-OCC} that translates to a value of n₀ such that one or more of OCC codeword misalignment or DMRS pattern misalignment are avoided.

Particular aspects of the subject matter described in this disclosure can be implemented to realize one or more of the following potential advantages. In some examples, the described techniques can be used to prevent one or more of OCC codeword misalignment or DMRS pattern misalignment, thereby improving one or more of performance or capacity. For example, aligning OCC codewords may enable a network node to decode multiplexed NPUSCH communications, thereby exploiting capacity gains offered by OCC. Additionally or alternatively, aligning DMRS patterns may help to ensure that a single DMRS per UE is transmitted per DMRS symbol, thereby improving one or more of channel estimation or carrier frequency offset estimation, and thus, increasing performance.

The NB-IoT uplink slot n₀ having a slot index that is equal to a multiple of K×M, or the slot index modulo K×M being equal to an offset, may introduce little or no signaling overhead between the UE and the network node. For example, the UE and the network node may identify the NB-IoT uplink slot n₀ using K and M.

Selecting a value of k₀ in accordance with the OCC multiplexing factor M may introduce little or no UE-side complexity because the network node may be responsible for identifying the value of k₀.

The NB-IoT uplink slot n₀ having a slot index that depends on k_{0-OCC} may introduce little signaling overhead between the UE and the network node and little or no UE-side complexity. Little signaling overhead may be introduced because k_{0-OCC} may occupy only log₂(KM) bits, and little or n₀ UE-side complexity because the network node may be responsible for identifying the value of k_{0-OCC}.

As described above, wireless communication systems may be deployed to provide various services, which may involve carrying or supporting voice, text, other messaging, video, data, or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, or device transmit power, among other examples). Examples of such multiple-access RATs include CDMA systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, IoT networks or reduced capability (RedCap) device deployments, ultra-reliable low-latency communication (URLLC) applications, or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies or support one or more of the foregoing use cases or new use cases.

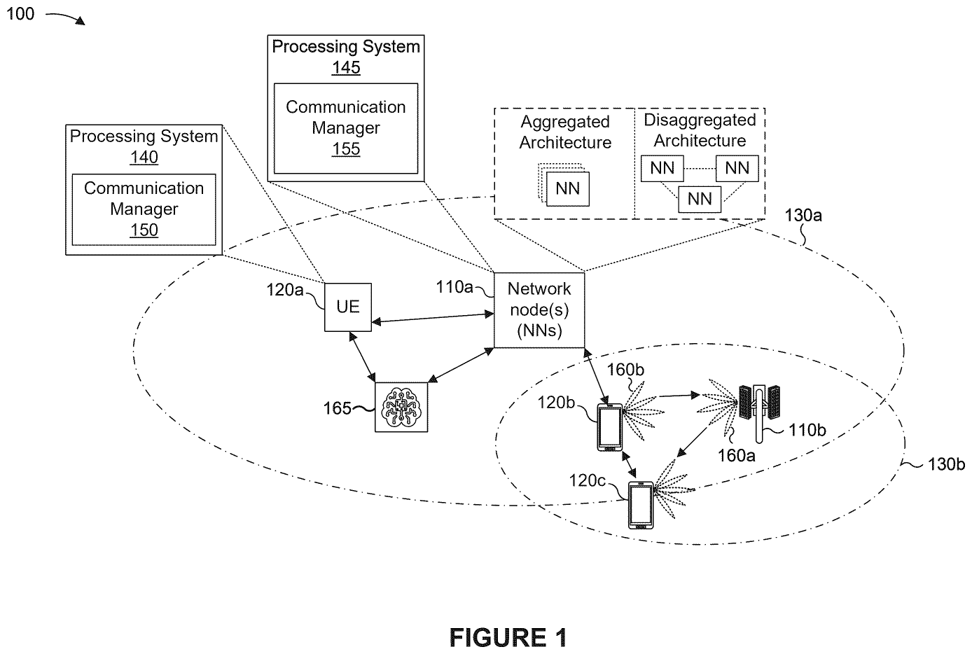

FIG. 1 is a diagram illustrating an example of a wireless communication network 100. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHZ), FR2 (24.25 GHz through 52.6 GHz), FR3 (7.125 GHz through 24.25 GHZ), FR4a or FR4-1 (52.6 GHz through 71 GHz), FR4 (52.6 GHz through 114.25 GHZ), and FR5 (114.25 GHz through 300 GHz). Although a portion of FR1 is greater than 6 GHz, FR1 is often referred to (interchangeably) as a “sub-6 GHZ” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHZ, that are within FR1, or that are included in mid-band frequencies. Similarly, the term “millimeter wave,” if used herein, may broadly refer to mid-band frequencies or to frequencies that are within FR2, FR4, FR4-a or FR4-1, FR5, or the EHF band. Higher frequency bands may extend 5G NR operation, 6G operation, or other RATs beyond 52.6 GHz.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 or the processing system 145 include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

Alternatively, and as also shown, a network node 110 may be a disaggregated network node (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, or disaggregated network nodes, among other examples. Various different types of network nodes 110 may generally transmit at different power levels, serve different coverage areas (for example, a cell 130a and a cell 130b), or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, or any other suitable device or function that may communicate via a wireless medium.

Some UEs 120 may be classified according to different categories in association with different complexities or different capabilities. UEs 120 in a first category may facilitate massive IoT in the wireless communication network 100, and may offer low complexity or cost relative to UEs 120 in a second category. UEs 120 in a second category may include mission-critical IoT devices, legacy UEs, baseline UEs, high-tier UEs, advanced UEs, full-capability UEs, or premium UEs that are capable of URLLC, eMBB, or precise positioning in the wireless communication network 100, among other examples. A third category of UEs 120 may have mid-tier complexity or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, or an NR-Lite UE, among other examples. RedCap UEs may bridge a gap between the capability and complexity of NB-IoT devices or eMTC UEs, and mission-critical IoT devices or premium UEs. RedCap UEs may include, for example, wearable devices, IoT devices, industrial sensors, or cameras that are associated with a limited bandwidth, power capacity, or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams 160a or 160b). Additionally, or alternatively, the network node 110 or the UE 120 may communicate with one or more devices 165 (for example, one or more network nodes 110, one or more UEs 120, one or more servers, or one or more components of a cloud computing network, among other examples).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), a radio resource control (RRC) message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, or one or more coupled modems) may perform signal processing on the information (such as filtering, amplification, modulation, digital-to-analog conversion, an inverse fast Fourier transform (IFFT) operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, a fast Fourier transform (FFT) operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some aspects, the UE 120 may include a communication manager 150. As described in more detail elsewhere herein, the communication manager 150 may transmit a UE capability indication associated with multiplexing; receive, in accordance with the UE capability indication, an indication of an OCC multiplexing factor; and transmit a narrowband uplink communication at a time in accordance with the OCC multiplexing factor. Additionally or alternatively, the communication manager 150 may perform one or more other operations described herein.

In some aspects, the network node 110 may include a communication manager 155. As described in more detail elsewhere herein, the communication manager 155 may receive a UE capability indication associated with multiplexing; transmit, in accordance with the UE capability indication, an indication of an OCC multiplexing factor; and receive a narrowband uplink communication at a time in accordance with the OCC multiplexing factor. Additionally or alternatively, the communication manager 155 may perform one or more other operations described herein.

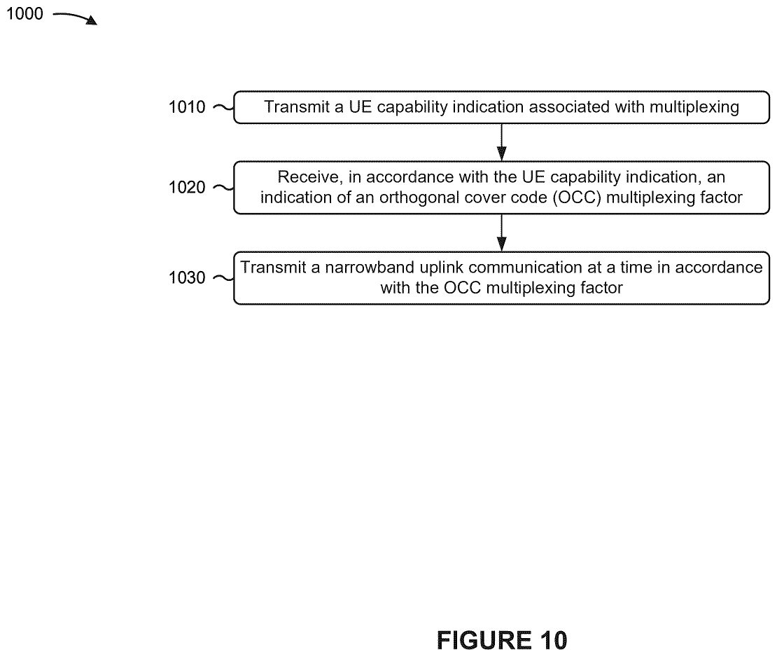

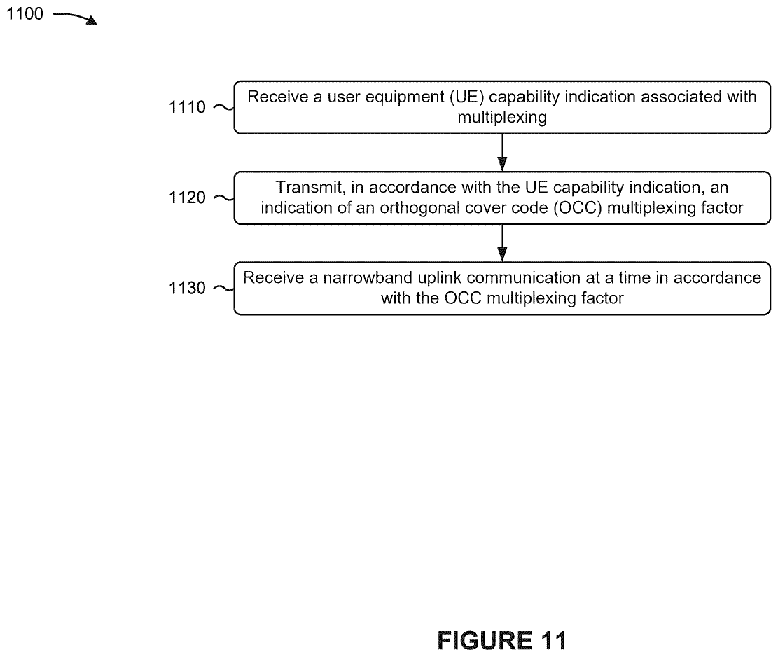

The network node 110, the processing system 145 of the network node 110, the UE 120, the processing system 140 of the UE 120, a centralized unit (CU), a distributed unit (DU), a radio unit (RU), or any other component(s) of FIG. 1 may implement one or more techniques or perform one or more operations associated with narrowband uplink communication times in accordance with an orthogonal cover code multiplexing factor, as described in more detail elsewhere herein. For example, the processing system 145 of the network node 110, the processing system 140 of the UE 120, a CU, a DU, or an RU may perform or direct operations of, for example, process 1000 of FIG. 10, process 1100 of FIG. 11, or other processes as described herein (alone or in conjunction with one or more other processors). Memory of the network node 110 may store data and program code (or instructions) for the network node 110, a CU, a DU, or an RU. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, a CU, a DU, or an RU, may cause the one or more processors to perform process 1000 of FIG. 10, process 1100 of FIG. 11, or other processes as described herein. In some examples, executing instructions may include running the instructions, converting the instructions, compiling the instructions, or interpreting the instructions, among other examples.

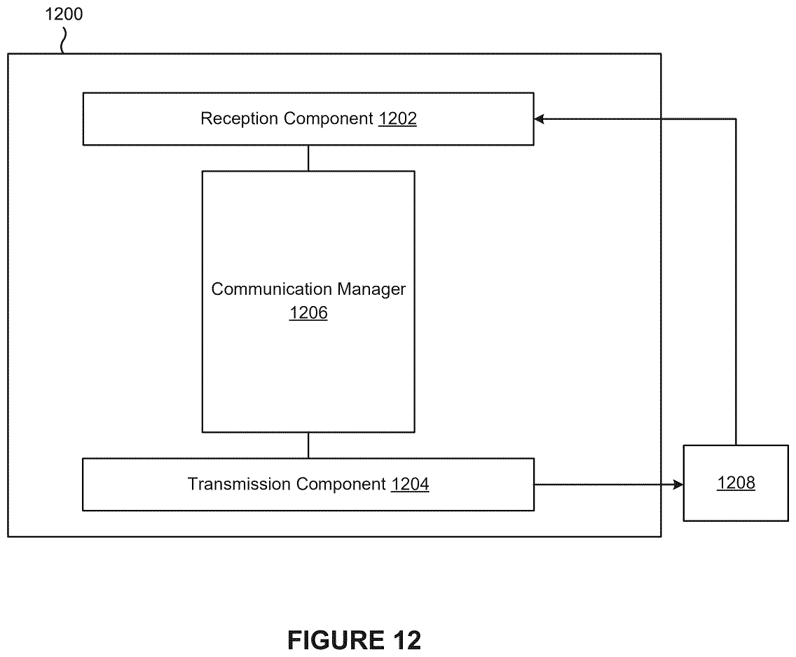

In some aspects, the UE 120 includes means for transmitting a UE capability indication associated with multiplexing; means for receiving, in accordance with the UE capability indication, an indication of an OCC multiplexing factor; or means for transmitting a narrowband uplink communication at a time in accordance with the OCC multiplexing factor. The means for the UE 120 to perform operations described herein may include, for example, one or more of communication manager 150, processing system 140, a radio, one or more RF chains, one or more transceivers, one or more antennas, one or more modems, a reception component (for example, reception component 1202 depicted and described in connection with FIG. 12), or a transmission component (for example, transmission component 1204 depicted and described in connection with FIG. 12), among other examples.

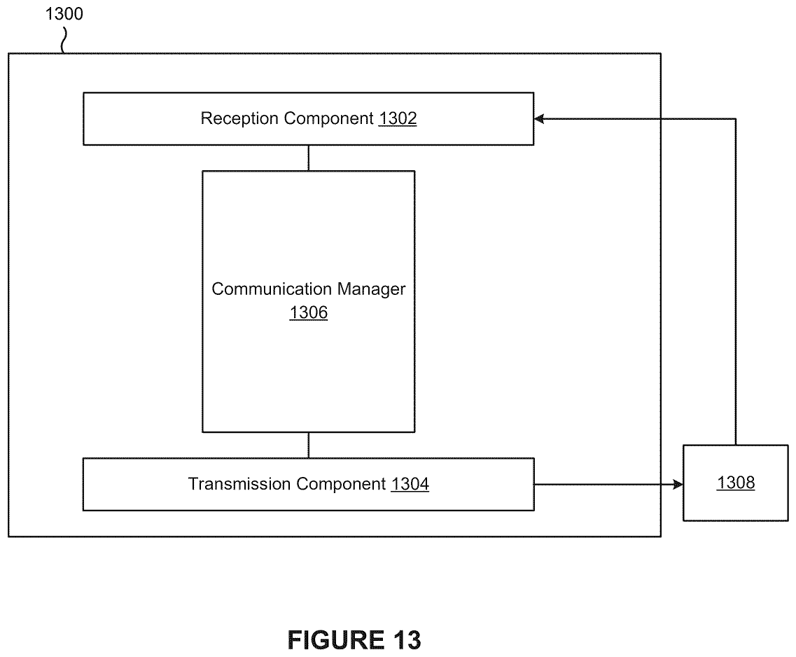

In some aspects, the network node includes means for receiving a UE 120 capability indication associated with multiplexing; means for transmitting, in accordance with the UE capability indication, an indication of an OCC multiplexing factor; or means for receiving a narrowband uplink communication at a time in accordance with the OCC multiplexing factor. The means for the network node to perform operations described herein may include, for example, one or more of communication manager 155, processing system 145, a radio, one or more RF chains, one or more transceivers, one or more antennas, one or more modems, a reception component (for example, reception component 1302 depicted and described in connection with FIG. 13), or a transmission component (for example, transmission component 1304 depicted and described in connection with FIG. 13), among other examples.

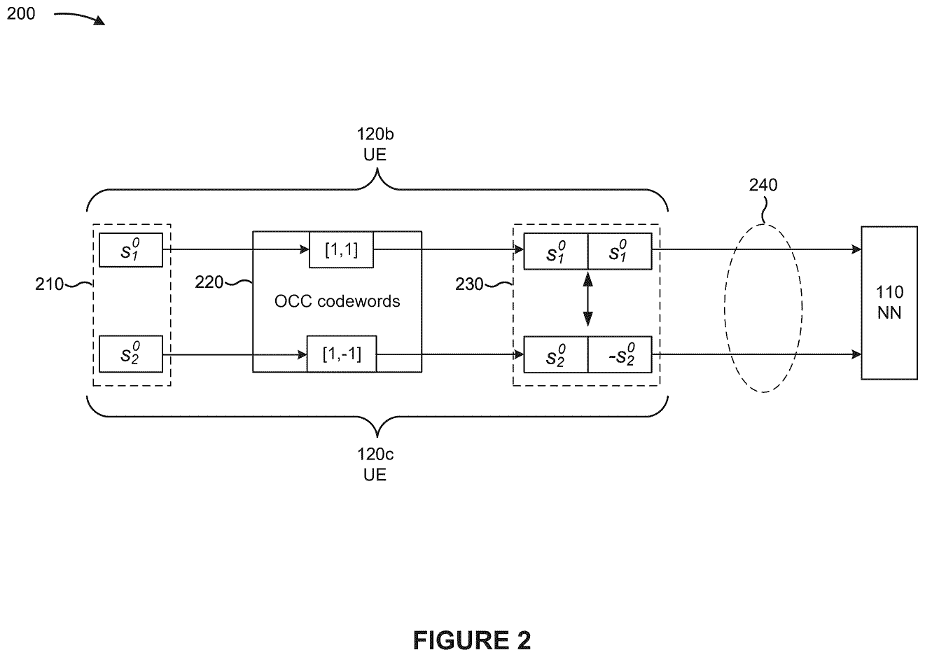

FIG. 2 is a diagram illustrating an example 200 of OCC for two UEs 120b and 120c.

An OCC procedure may involve an OCC multiplexing factor M, which denotes a quantity of UEs multiplexed by the OCC procedure. In example 200, M=2, corresponding to UEs 120b and 120c. In a first operation 210, the UE 120b may generate a first signal

$${s}_{1}^{0} ,$$

and UE 1200 may generate a second signal

$${s}_{2}^{0} ,$$

where a signal

$${s}_{i}^{j}$$

is associated with a RE j by UE i. In some examples, a signal

$${s}_{i}^{j}$$

may be associated with a time resource (for example, a symbol or a slot, among other examples) referred to as an “original entity.”

In a second operation 220, the UE 120b may apply a first OCC codeword of [1, 1] to the first signal

$${s}_{1}^{0} ,$$

and the UE 120c may apply a second OCC codeword of [1, −1] to the second symbol

$${s}_{2}^{0} .$$

The OCC codewords may have a quantity of elements equal to the OCC multiplexing factor M (here, 2).

In a third operation 230, responsive to the application of the OCC codewords, the first signal

$${s}_{1}^{0}$$

may be converted to multiple first signals

$${s}_{1}^{0} and {s}_{1}^{0} ,$$

and the second signal

$${s}_{2}^{0}$$

may converted to multiple second signals

$${s}_{2}^{0} and - {s}_{2}^{0} .$$

As a result, an original entity may be converted (or “spread”) into multiple spread entities, where a quantity of the multiple spread entities is equal to the OCC multiplexing factor M (here, 2). The multiple first signals

$${s}_{1}^{0} and {s}_{1}^{0}$$

may be orthogonal to the multiple second signals

$${s}_{2}^{0} and - {s}_{2}^{0} .$$

In a fourth operation 240, the UEs 120b and 120c may transmit, and the network node 110 may receive, the multiple first signals

$${s}_{1}^{0} and {s}_{1}^{0}$$

and the multiple second signals

$${s}_{2}^{0} and - {s}_{2}^{0} .$$

Being orthogonal to each other, these signals may share the same REs. Thus, OCC may multiplex the UE 120b and 120c while mitigating interference at the network node 110.

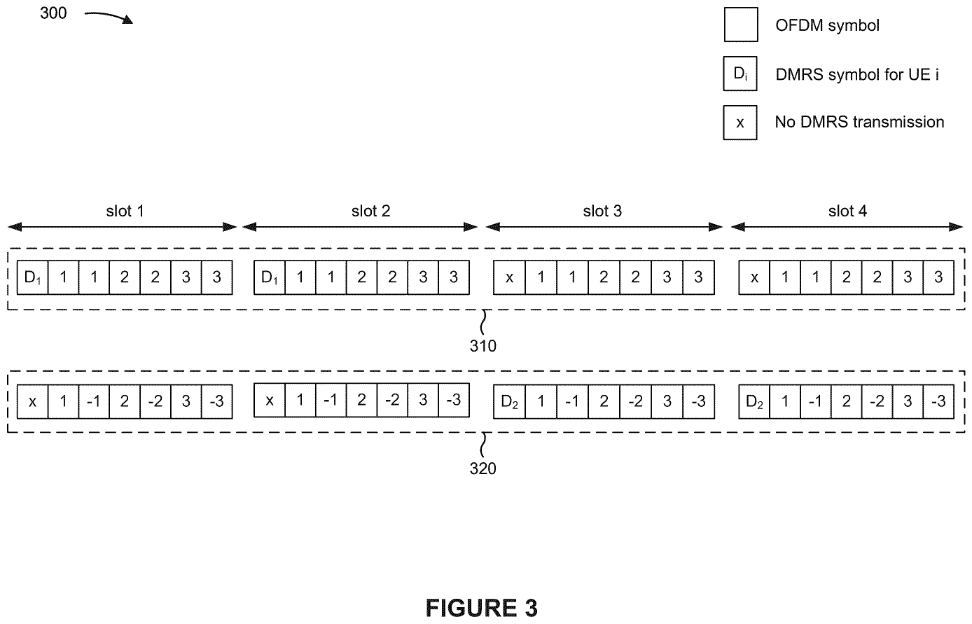

FIG. 3 is a diagram illustrating an example 300 of time-division multiplexing (TDM) DMRS patterns in OCC (OCC is described above in connection with FIG. 2).

Example 300 involves symbol-wise OCC2 (meaning that an original entity or a spread entity is a symbol and the OCC multiplexing factor M is 2) in a single-tone 3.75 kHz SCS scenario for slots 1-4. Each slot may include seven symbols (for example, OFDM symbols). For example, the slots may include an initial symbol allocated for DMRS and six subsequent symbols corresponding to respective OCC codewords. A first mapping 310 shows how the DMRS and OCC codewords are mapped to the symbols for the UE 120b, and a second mapping 320 shows how the DMRS and OCC codewords are mapped to the symbols for the UE 120c.

The UE 120b may transmit a DMRS for M consecutive slots, and then the UE 120c may transmit a DMRS for M consecutive slots. In example 300, M=2; thus, in slots 1 and 2, the UE 120b may transmit a DMRS and the UE 120c may refrain from transmitting a DMRS, and in slots 3 and 4, the UE 120c may transmit a DMRS and the UE 120b may refrain from transmitting a DMRS. Because the DMRSs do not use OCC, if transmitted in the same slot, the DMRSs would not be decodable due to interference. In examples where DMRSs use OCC, the DMRSs may be treated similarly to data that uses OCC.

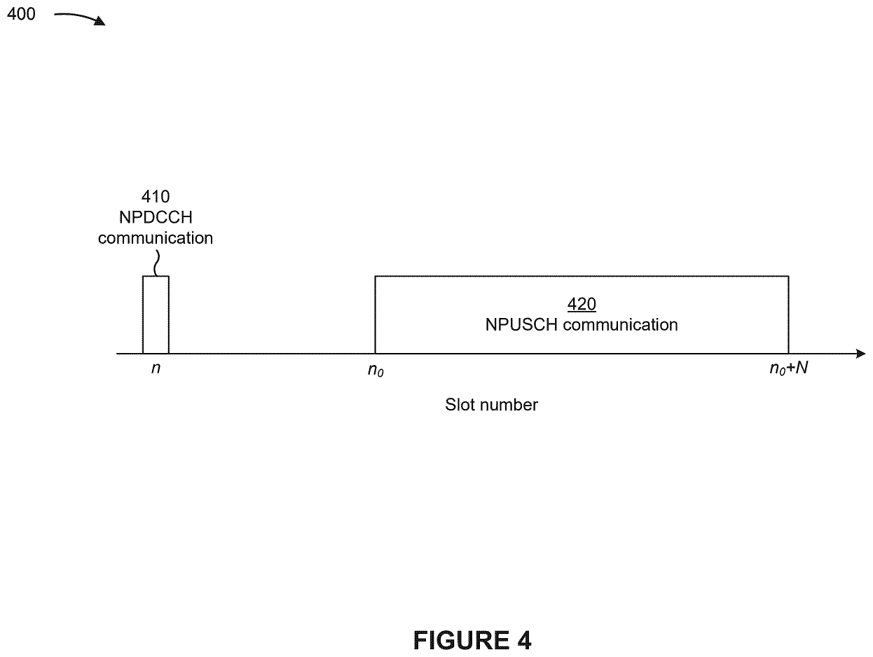

FIG. 4 is a diagram illustrating an example 400 of UE procedures for transmitting narrowband PUSCH (NPUSCH) communications.

In some examples, a network node 110 may transmit, and a UE 120 may receive, a narrowband PDCCH (NPDCCH) communication 410 that schedules an NPUSCH communication 420. For example, the NPDCCH communication 410 may end in NB-IoT downlink subframe n. The UE 120 may transmit, and the network node 110 may receive, the NPUSCH communication 420 scheduled by the NPDCCH communication 410. For example, the NPUSCH communication 420 may start in a NB-IoT uplink slot n₀ and extend for N consecutive NB-IoT uplink slots.

For frequency division duplex (FDD), the NB-IoT uplink slot n₀ may be a first NB-IoT uplink slot n₀ after the end of subframe n+k₀+K_{offset}, where k₀ may be a scheduling delay offset, and K_{offset} may be any suitable integer between 0 and 1023, inclusive. Table 1 below illustrates possible values for k₀ with corresponding scheduling delay offsets I_{Delay} indicated in DCI (for example, DCI format N0) for FDD.

TABLE 1

| I_{Delay} | K_{offset} |
|---|---|
| 0 | 8 |
| 1 | 16 |
| 2 | 32 |
| 3 | 64 |

For time division duplex (TDD), the NB-IoT uplink slot n₀ may be a first NB-IoT uplink slot starting after k₀ NB-IoT uplink subframes following the end of n+8 subframe. Table 2 below illustrates possible values for k₀ with corresponding scheduling delay offsets I_{Delay} indicated in DCI (for example, DCI format N0) for TDD.

TABLE 2

| I_{Delay} | K_{offset} |
|---|---|
| 0 | 0 |
| 1 | 8 |
| 2 | 16 |
| 3 | 32 |

In some examples, NPUSCH capacity may be enhanced using OCC (OCC is described above in connection with FIG. 2). For example, OCC may be applied to NPUSCH for NB-IoT NTN. For example, symbol-level OCC (where an original entity or a spread entity is a symbol) may be applied to a SCS corresponding to single 3.75 kHz subcarriers in NPUSCH for connected mode. Additionally or alternatively, slot-level OCC (where an original entity or a spread entity is a slot) may be applied to a SCS corresponding to single 15 kHz subcarriers for NPUSCH communications.

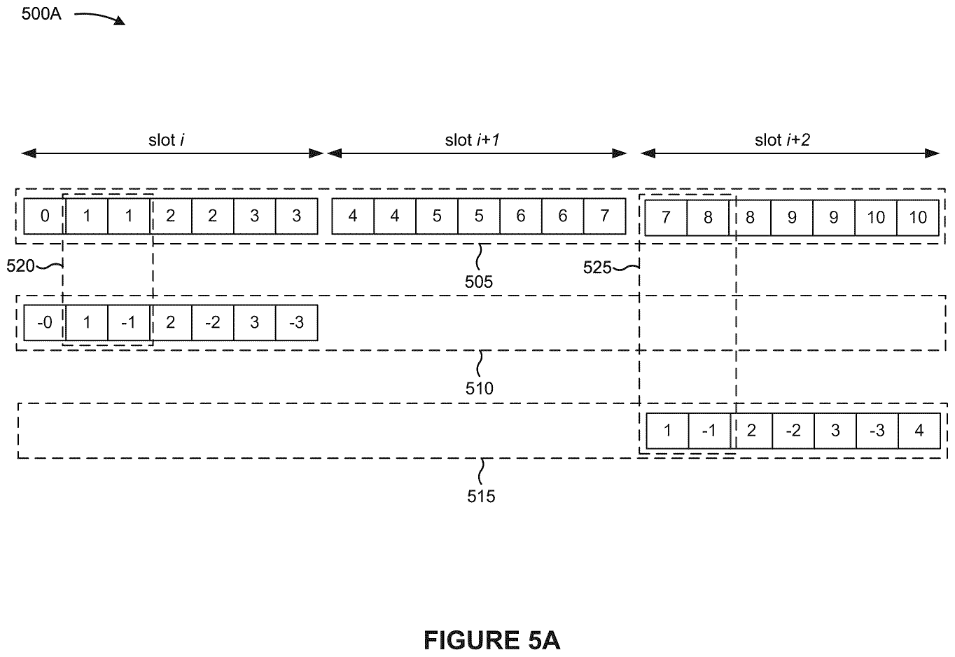

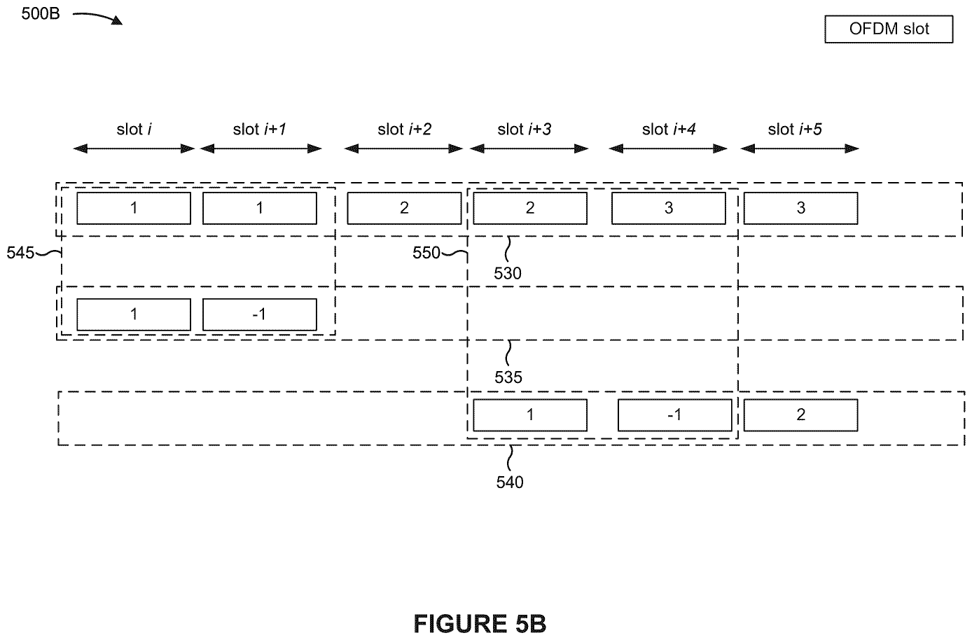

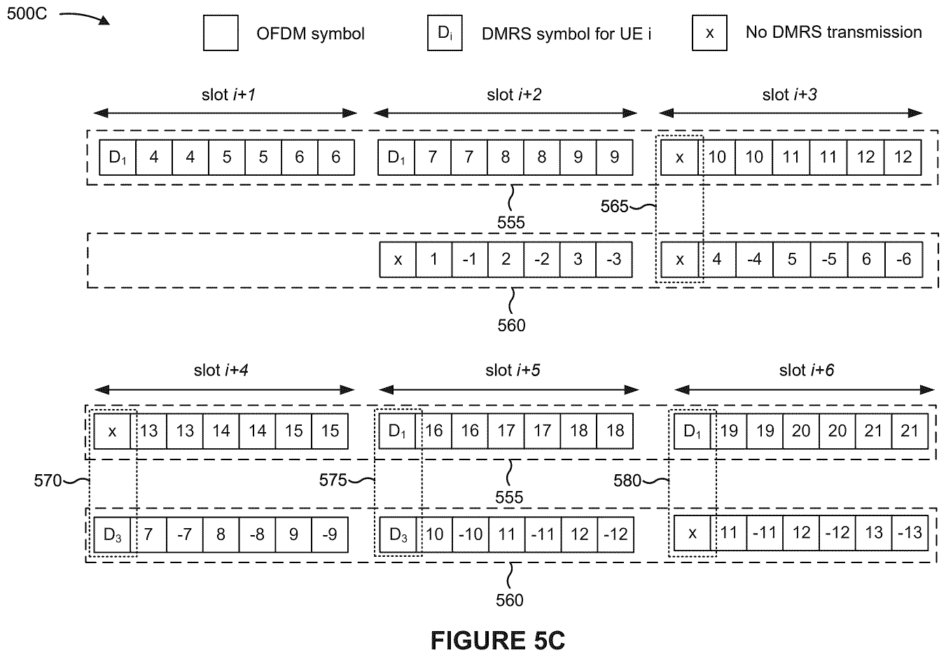

FIGS. 5A-5C are diagrams illustrating examples 500A, 500B, and 500C of misalignment in OCC.

Transmitting an NPUSCH communication using OCC for NB-IoT NTN using an arbitrary NB-IoT uplink slot n₀ (for example, where the NB-IoT uplink slot n₀ is a first NB-IoT uplink slot n₀ after the end of subframe n+k₀+K_{offset}, as discussed above in connection with FIG. 4) may cause one or more of OCC codeword misalignment or DMRS pattern misalignment, resulting in performance or capacity loss. The misalignment may render NPUSCH communications that are multiplexed using OCC undecodable at a receiver (such as a network node). As a result, NB-IoT NTN systems using NPUSCH with OCC may lose performance or capacity due to failed NPUSCH communications or retransmissions, among other examples.

With reference to FIG. 5A, example 500A illustrates OCC codeword misalignment in symbol-wise OCC2 in a single-tone 3.75 kHz SCS scenario for slots i, i+1, and i+2. Each slot may include seven symbols (for example, OFDM symbols), each corresponding to respective OCC codewords. A first mapping 505 shows how the OCC codewords are mapped to the symbols for the UE 120b, a second mapping 510 shows how the OCC codewords are mapped to the symbols for the UE 120c, and a third mapping 515 shows how the OCC codewords are mapped to the symbols for the UE 120a.

Symbols 520 are two symbols that have been spread from one symbol, as described above in connection with FIG. 2. The OCC codeword for UE 120b is [1, 1] and for UE 120c is [1, −1]. As a result, two copies of each symbol may be scaled accordingly for each UE 120b and 120c, and the OCC codewords corresponding to the symbols 520 are aligned. For example, UE 120b may apply the OCC codeword [1, 1] to one symbol, which may spread into two symbols 520. Similarly, UE 120c may apply the OCC codeword [1, −1] to one symbol, which may spread into two symbols 520. Thus, signals transmitted by the UE 120b and the UE 120c in the symbols 520 may be orthogonal to each other, and the network node 110 may successfully decode the signals.

As shown, the UE 120c may finish an NPUSCH transmission at the end of slot i, and the UE 120a may start an NPUSCH transmission at the beginning of slot i+2 in accordance with a scheduling NPDCCH and the NB-IoT uplink slot n₀. Because the NB-IoT uplink slot n₀ can be arbitrary, OCC codeword misalignment occurs between the UE 120b and the UE 120a. As a result, two copies of each symbol may be scaled accordingly for UE 120a, but not for UE 120c, and the OCC codewords corresponding to the symbols 525 are misaligned (for example, copies of symbols generated by spreading are not aligned in symbols 525). Thus, signals transmitted by the UE 120c and the UE 120a in the symbols 525 may not be orthogonal to each other, and the network node 110 may be unable to decode the signals. This misalignment may continue in subsequent symbols.

With reference to FIG. 5B, example 500B illustrates OCC codeword misalignment in slot-wise OCC2 in a single-tone 15 kHz SCS scenario for slots i, i+1, i+2, i+3, i+4, and i+5. A first mapping 530 shows how the OCC codewords are mapped to the slots for the UE 120b, a second mapping 535 shows how the OCC codewords are mapped to the slots for the UE 120c, and a third mapping 540 shows how the OCC codewords are mapped to the slots for a third UE (for example, the UE 120a).

Slots 545 are two slots that have been spread from one slot, as described above in connection with FIG. 2. As a result, two copies of each slot may be scaled accordingly for each UE 120b and 120c, and the OCC codewords corresponding to the slots 545 are aligned (for example, copies of slots generated by spreading are aligned in slots 545). Thus, signals transmitted by the UE 120b and the UE 120c in the slots 545 may be orthogonal to each other, and the network node 110 may successfully decode the signals.

As shown, the UE 120c may finish an NPUSCH transmission at the end of slot i+1, and the UE 120a may start an NPUSCH transmission at the beginning of slot i+3 in accordance with a scheduling NPDCCH and the NB-IoT uplink slot n₀. Because the NB-IoT uplink slot n₀ can be arbitrary, OCC codeword misalignment occurs between the UE 120b and the UE 120a. As a result, two copies of each slot may be scaled accordingly for UE 120a, but not for UE 120c, and the OCC codewords corresponding to the slots 550 are misaligned (for example, copies of slots generated by spreading are not aligned in slots 550). Thus, signals transmitted by the UE 120c and the UE 120a in the slots 550 may not be orthogonal to each other, and the network node 110 may be unable to decode the signals. This misalignment may continue in subsequent slots.

With reference to FIG. 5C, example 500C illustrates DMRS pattern misalignment in symbol-wise OCC2 in a single-tone 3.75 kHz SCS scenario for slots i+1, i+2, i+3, i+4, i+5, and i+6. Each slot may include seven symbols (for example, OFDM symbols). For example, the slots may include an initial symbol allocated for DMRS and six subsequent symbols corresponding to respective OCC codewords, as discussed above in connection with FIG. 3. A first mapping 555 shows how the DMRS and OCC codewords are mapped to the symbols for the UE 120b, and a second mapping 560 shows how the DMRS and OCC codewords are mapped to the slots for a third UE (for example, the UE 120a).

The UE 120c may finish an NPUSCH transmission at the end of slot i (not shown), and the UE 120a may start an NPUSCH transmission at the beginning of slot i+2 in accordance with a scheduling NPDCCH and the NB-IoT uplink slot n₀. Because the NB-IoT uplink slot n₀ can be arbitrary, DMRS pattern misalignment occurs between the UE 120b and the UE 120a. For example, in symbol 565 (which is the initial symbol in slot i+3), neither the UE 120c nor the UE 120a transmit a DMRS, which decreases resource utilization efficiency. In symbol 570 (which is the initial symbol in slot i+4), the UE 120a may transmit a DMRS and the UE 120b may refrain from transmitting a DMRS; thus, the DMRS transmitted by the UE 120a may be received by the network node 110 correctly. In symbol 575 (which is the initial symbol in slot i+5), both the UE 120c and the UE 120a transmit a DMRS, which may prevent the network node 110 from decoding the DMRSs due to interference. In symbol 580 (which is the initial symbol in slot i+6), the UE 120b may transmit a DMRS and the UE 120a may refrain from transmitting a DMRS; thus, the DMRS transmitted by the UE 120b may be received by the network node 110 correctly. Empty symbols (such as symbol 565) or symbols with overlapping DMRSs (such as symbol 575) may lead to poor channel estimation or carrier frequency offset estimation, and, thus, performance loss. This misalignment may continue in subsequent symbols.

Accordingly, various transmission procedures may help to prevent OCC codeword misalignment or DMRS pattern misalignment for NPUSCH in NB-IoT NTN systems, and help to exploit capacity gains offered by OCC. Some aspects may, rather than permitting the NB-IoT uplink slot n₀ to be arbitrary, constrain a set of candidate slots to which the NB-IoT uplink slot n₀ can be assigned.

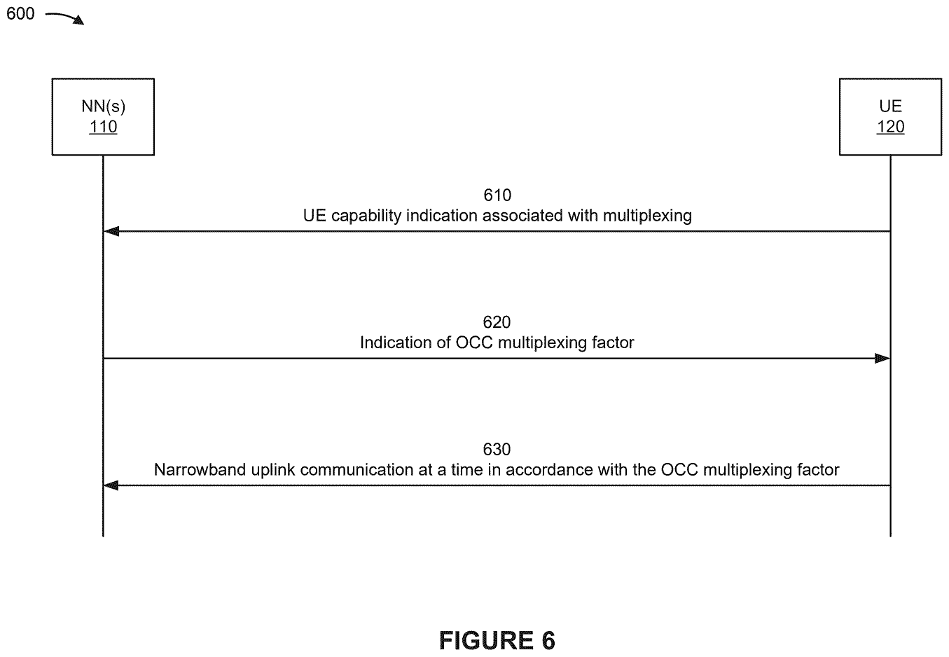

FIG. 6 is a diagram illustrating an example 600 associated with signaling for OCC-multiplexing-factor-based narrowband uplink communication times. As shown in FIG. 6, a network node 110 and a UE 120 may communicate with one another (e.g., using FDD).

In a first operation 610, the UE 120 may transmit, and the network node 110 may receive, a UE capability indication associated with multiplexing. The UE capability indication may be associated with multiplexing in that the UE capability indication may indicate that the UE 120 can support multiplexing. In some examples, a capability of the UE 120 to support multiplexing may depend on one or more phase coherence capabilities of the UE 120.

In a second operation 620, the network node 110 may transmit, and the UE 120 may receive, an indication of an OCC multiplexing factor. The network node 110 may transmit, and the UE 120 may receive, the indication of the OCC multiplexing factor in accordance with the UE capability indication (for example, the network node 110 may transmit the indication of the OCC multiplexing factor responsive to the UE 120 indicating that the UE 120 can support multiplexing). The OCC multiplexing factor may be the OCC multiplexing factor M as discussed above in connection with FIG. 2. Additionally or alternatively, the network node 110 may transmit, and the UE 120 may receive, an OCC configuration that includes the indication of the OCC multiplexing factor. Additionally, or alternatively, the OCC configuration may indicate an OCC codeword as discussed above in connection with FIG. 2. Additionally or alternatively, the OCC configuration may configure the UE 120 with UE-specific information regarding NPUSCH with OCC. The OCC configuration may comprise via RRC or DCI, among other examples.

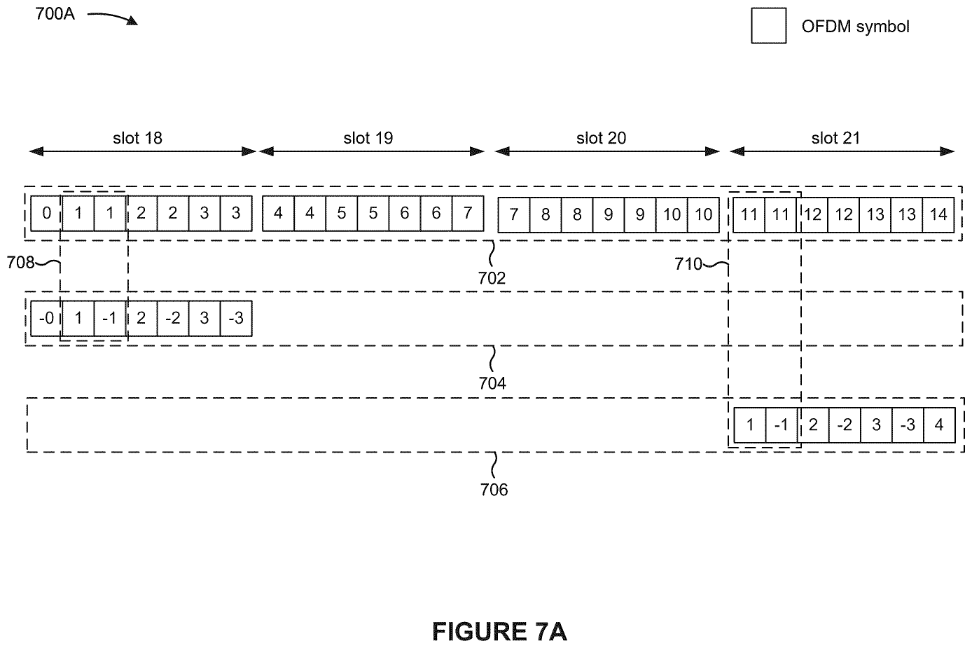

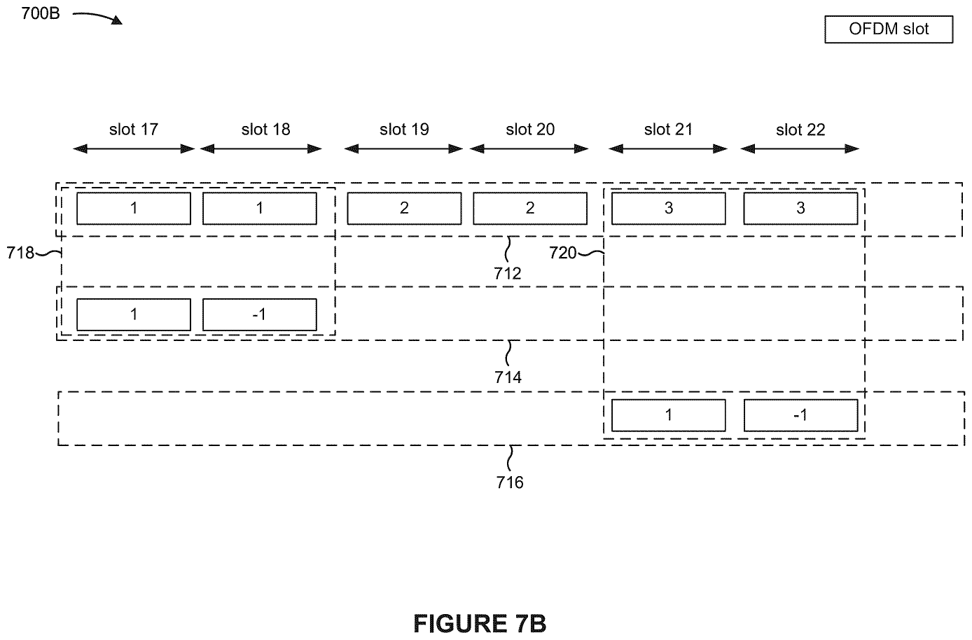

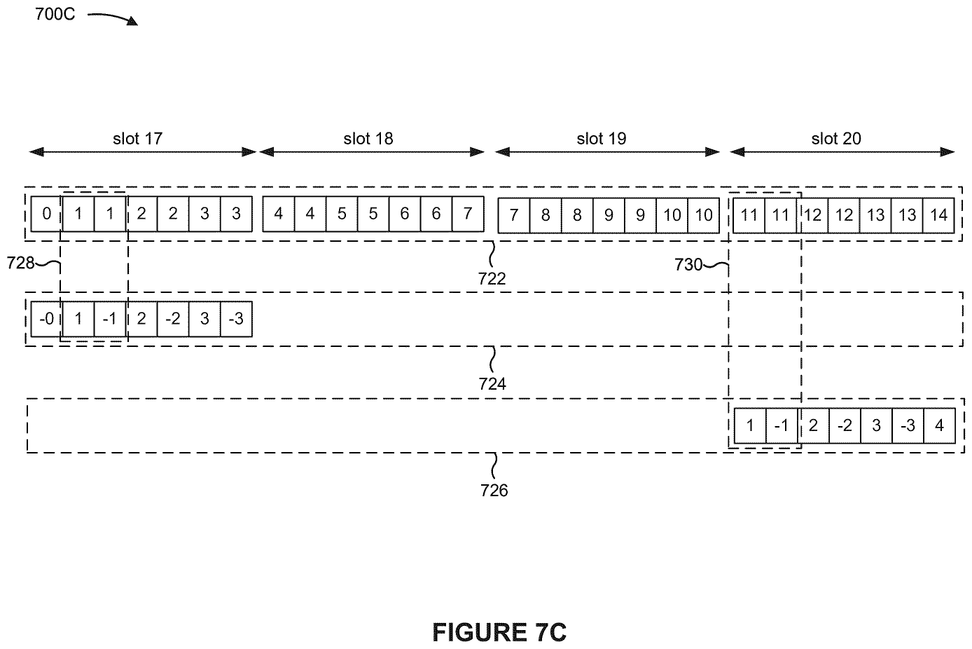

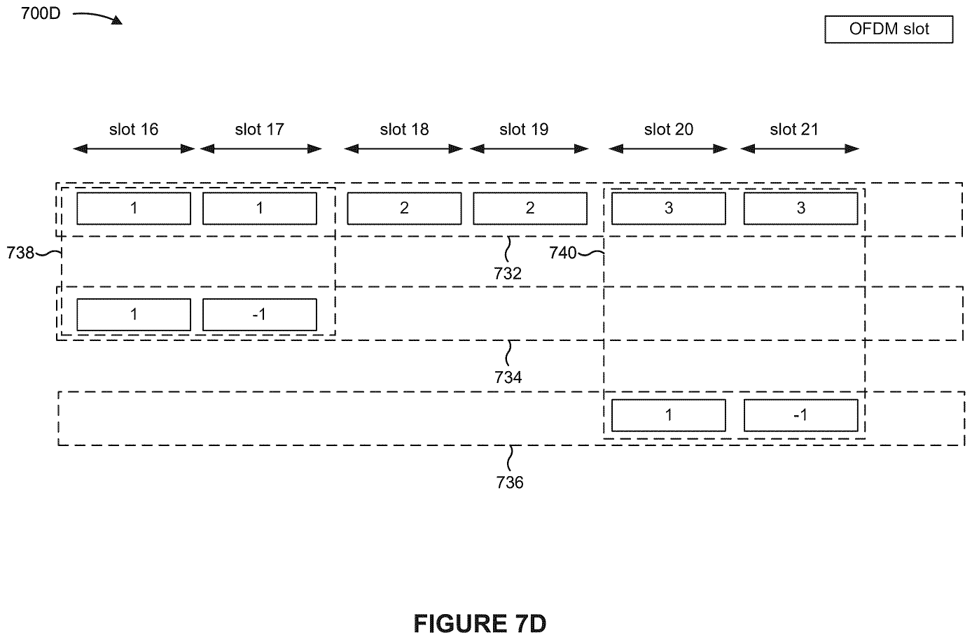

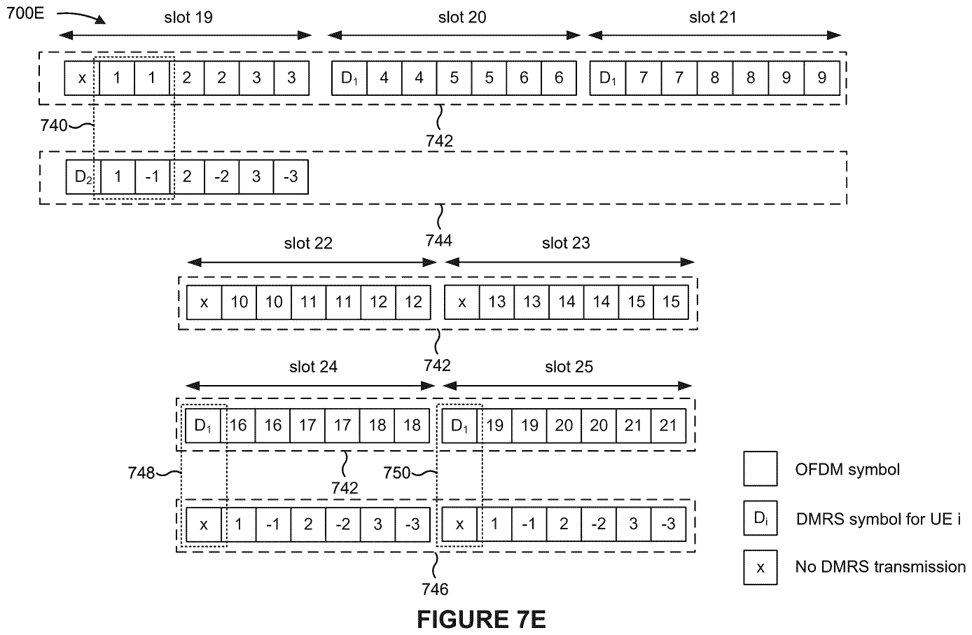

In a third operation 630, the UE 120 may transmit, and the network node 110 may receive, a narrowband uplink communication at a time (for example, a start time) in accordance with the OCC multiplexing factor. For example, the UE 120 may transmit the narrowband uplink communication using OCC. In some examples, the narrowband uplink communication may be an NPUSCH communication as described above in connection with FIG. 4. In some examples, the time may be the NB-IoT uplink slot n₀ as described above in connection with FIG. 4. As described in greater detail below in connection with FIGS. 7A-9C, the UE 120 may transmit and the network node 110 may receive the narrowband uplink communication at the time in accordance with the OCC multiplexing factor such that the narrowband uplink communication avoids one or more of OCC codeword misalignment or DMRS pattern misalignment.

FIGS. 7A-7E are diagrams illustrating examples 700A-700E associated with first aspects for OCC-multiplexing-factor-based narrowband uplink communication times.

In some aspects, a slot index associated with the time is a first integer multiple of a second integer multiple of the OCC multiplexing factor, or the slot index modulo the second integer multiple of the OCC multiplexing factor is equal to a constant across UEs associated with the OCC multiplexing factor. The slot index may be an absolute slot number that is calculated in accordance with a system frame number, frame number, or subframe number, among other examples. The slot index may be associated with the time in that the slot index may correspond to a slot (for example, a starting slot) that includes the time, such as the NB-IoT uplink slot n₀. In some examples, the second integer multiple may be denoted by K, and the slot index may be equal to the first integer multiple of K×M, or the slot index modulo K×M may be equal to the constant (for example, an offset). The value of K may be predefined in a wireless communication standard or configured via RRC or DCI, among other examples. The UEs may be associated with the OCC multiplexing factor in that the UEs (for example, including the UE 120) may use OCC to communicate with the network node 110 in accordance with the OCC multiplexing factor. For example, if M=2, then the UEs may include the UE 120 and another UE.

Thus, in some examples, if OCC for NPUSCH is enabled, then n₀ may be the first NB-IoT uplink slot starting after the end of subframe n+k₀+K_{offset} for FDD and no modulo M may always be equal to a given constant, or n₀ may be the first NB-IoT uplink slot which is a multiple of M starting after the end of subframe n+k₀+K_{offset} for FDD; otherwise, n₀ may be the first NB-IoT uplink slot starting after the end of subframe n+k₀+K_{offset} for FDD. Additionally or alternatively, if OCC for NPUSCH is enabled, then n₀ may be the first NB-IoT uplink slot starting after the end of subframe n+k₀+K_{offset} for FDD and n₀ modulo 2M may always be equal to a given constant, or n₀ may be the first NB-IoT uplink slot which is a multiple of 2M starting after the end of subframe n+k₀+K_{offset} for FDD; otherwise, n₀ may be the first NB-IoT uplink slot starting after the end of subframe n+k₀+K_{offset} for FDD.

In some aspects (such as aspects for preventing OCC codeword misalignment), the second integer multiple is one. For example, the slot index may be the first integer multiple of the OCC multiplexing factor, or the slot index modulo the OCC multiplexing factor may be equal to the constant. In some examples, K=1, and the slot index may be a multiple of M, or the slot index modulo M may be constant. In examples 700A-700D (discussed in greater detail below in connection with preventing OCC codeword misalignment), the second integer multiple is one.

In some aspects, the slot index modulo the OCC multiplexing factor is equal to the constant. For example, n₀ may be the first NB-IoT uplink slot that starts after the end of subframe n+k₀+K_{offset} for FDD, where n₀ modulo M is equal to the constant. In some aspects, the constant may be predefined. For example, the constant may be predefined in the wireless communication standard. In some aspects, the network node 110 may transmit, and the UE 120 may receive, an indication of the constant. For example, the constant may be configured via RRC or DCI, among other examples.

In examples 700A and 700B, the slot index modulo the OCC multiplexing factor is equal to the constant. With reference to FIG. 7A, example 700A illustrates OCC codeword alignment in symbol-wise OCC2 in a single-tone 3.75 kHz SCS scenario for slots 18-21. Each slot may include seven symbols (for example, OFDM symbols), each corresponding to respective OCC codewords. A first mapping 702 shows how the OCC codewords are mapped to the symbols for the UE 120b, a second mapping 704 shows how the OCC codewords are mapped to the symbols for the UE 120c, and a third mapping 706 shows how the OCC codewords are mapped to the symbols for the UE 120a.

In example 700A, n₀ mod M (for example, the constant) is equal to 1. UEs 120b and 120c may start NPUSCH transmissions from slot indexes with n₀ mod M=1. For example, n₀ may equal 3 (because 3 mod 2=1). Furthermore, the length of NPUSCH transmissions for single-tone subcarrier 3.75 kHz may be an even quantity of slots because a minimum transmission length may be 16 slots and a multiple thereof. For example, the length of the NPUSCH transmission may be 32 slots for the UE 120b and 16 slots for the UE 120c.

Symbols 708 are two symbols that have been spread from one symbol, as described above in connection with FIG. 2. As a result, two copies of each symbol may be scaled accordingly for each UE 120b and 120c, and the OCC codewords corresponding to the symbols 708 are aligned (for example, copies of symbols generated by spreading are aligned in symbols 708). Thus, signals transmitted by the UE 120b and the UE 120c in the symbols 708 may be orthogonal to each other, and the network node 110 may successfully decode the signals.

As shown, the UE 120c may finish an NPUSCH transmission at the end of slot 18, and the UE 120a may start an NPUSCH transmission at the beginning of slot 21. The UE 120a may not start an NPUSCH transmission at the beginning of slot 20 (as discussed above in connection with FIG. 5A) because 20 mod 2=0 does not equal the constant 3 mod 2=1. Instead, the UE 120a may start an NPUSCH transmission at the beginning of slot 21 because slot 21 is the next slot that satisfies n₀ mod 2=1.

Symbols 710 are two symbols that have been spread from one symbol, as described above in connection with FIG. 2. As a result, two copies of each symbol may be scaled accordingly for each UE 120b and 120a, and the OCC codewords corresponding to the symbols 710 are aligned (for example, copies of symbols generated by spreading are aligned in symbols 710). Thus, signals transmitted by the UE 120b and the UE 120a in the symbols 710 may be orthogonal to each other, and the network node 110 may successfully decode the signals.

With reference to FIG. 7B, example 700B illustrates OCC codeword misalignment in slot-wise OCC2 in a single-tone 15 kHz SCS scenario for slots 17-22. A first mapping 712 shows how the OCC codewords are mapped to the slots for the UE 120b, a second mapping 714 shows how the OCC codewords are mapped to the slots for the UE 120c, and a third mapping 716 shows how the OCC codewords are mapped to the slots for the UE 120a.

In example 700B, n₀ mod M (for example, the constant) is equal to 1. UEs 120b and 120c may start NPUSCH transmissions from slot indexes with n₀ mod M=1. For example, n₀ may equal 3 (because 3 mod 2=1). Furthermore, the length of NPUSCH transmissions for single-tone subcarrier 15 kHz may be an even quantity of slots because a minimum transmission length may be 16 slots and a multiple thereof. For example, the length of the NPUSCH transmission may be 32 slots for the UE 120b and 16 slots for the UE 120c.

Slots 718 are two slots that have been spread from one slot, as described above in connection with FIG. 2. As a result, two copies of each slot may be scaled accordingly for each UE 120b and 120c, and the OCC codewords corresponding to the slots 718 are aligned (for example, copies of slots generated by spreading are aligned in slots 718). Thus, signals transmitted by the UE 120b and the UE 120c in the slots 718 may be orthogonal to each other, and the network node 110 may successfully decode the signals.

As shown, the UE 120c may finish an NPUSCH transmission at the end of slot 18, and the UE 120a may start an NPUSCH transmission at the beginning of slot 21. The UE 120a may not start an NPUSCH transmission at the beginning of slot 20 (as discussed above in connection with FIG. 5B) because 20 mod 2=0 does not equal the constant 3 mod 2=1. Instead, the UE 120a may start an NPUSCH transmission at the beginning of slot 21 because slot 21 is the next slot that satisfies n₀ mod 2=1.

Slots 720 are two slots that have been spread from one slot, as described above in connection with FIG. 2. As a result, two copies of each slot may be scaled accordingly for each UE 120b and 120a, and the OCC codewords corresponding to the slots 720 are aligned (for example, copies of slots generated by spreading are aligned in slots 720). Thus, signals transmitted by the UE 120b and the UE 120a in the slots 720 may be orthogonal to each other, and the network node 110 may successfully decode the signals.

In some aspects, the slot index is the first integer multiple of the OCC multiplexing factor. For example, n₀ may be the first NB-IoT uplink slot that is a multiple of M starting after the end of subframe n+k₀+K_{offset} for FDD. This example may correspond to n₀ modulo M (for example, the constant) being equal to zero.

In examples 700C and 700D, the slot index is the first integer multiple of the OCC multiplexing factor. With reference to FIG. 7C, example 700C illustrates OCC codeword alignment in symbol-wise OCC2 in a single-tone 3.75 kHz SCS scenario for slots 17-20. Each slot may include seven symbols (for example, OFDM symbols), each corresponding to respective OCC codewords. A first mapping 722 shows how the OCC codewords are mapped to the symbols for the UE 120b, a second mapping 724 shows how the OCC codewords are mapped to the symbols for the UE 120c, and a third mapping 726 shows how the OCC codewords are mapped to the symbols for the UE 120a.

In example 700C, n₀ mod M (for example, the constant) is equal to 0. UEs 120b and 120c may start NPUSCH transmissions from slot indexes that are multiples of M with n₀ mod M=0. For example, n₀ may equal 2 (because 2 mod 2=0). Furthermore, the length of NPUSCH transmissions for single-tone subcarrier 3.75 kHz may be an even quantity of slots because a minimum transmission length may be 16 slots and a multiple thereof. For example, the length of the NPUSCH transmission may be 32 slots for the UE 120b and 16 slots for the UE 120c.

Symbols 728 are two symbols that have been spread from one symbol, as described above in connection with FIG. 2. As a result, two copies of each symbol may be scaled accordingly for each UE 120b and 120c, and the OCC codewords corresponding to the symbols 728 are aligned (for example, copies of symbols generated by spreading are aligned in symbols 728). Thus, signals transmitted by the UE 120b and the UE 120c in the symbols 728 may be orthogonal to each other, and the network node 110 may successfully decode the signals.

As shown, the UE 120c may finish an NPUSCH transmission at the end of slot 17, and the UE 120a may start an NPUSCH transmission at the beginning of slot 20. The UE 120a may not start an NPUSCH transmission at the beginning of slot 19 (as discussed above in connection with FIG. 5A) because 19 is not a multiple of M=2 (and because 19 mod 2=1 does not equal the constant n₀ mod 2=0). Instead, the UE 120a may start an NPUSCH transmission at the beginning of slot 20 because slot 20 is the next slot having a slot index that is a multiple of M=2.

Symbols 730 are two symbols that have been spread from one symbol, as described above in connection with FIG. 2. As a result, two copies of each symbol may be scaled accordingly for each UE 120b and 120a, and the OCC codewords corresponding to the symbols 730 are aligned (for example, copies of symbols generated by spreading are aligned in symbols 730). Thus, signals transmitted by the UE 120b and the UE 120a in the symbols 730 may be orthogonal to each other, and the network node 110 may successfully decode the signals.

With reference to FIG. 7D, example 700D illustrates OCC codeword misalignment in slot-wise OCC2 in a single-tone 15 kHz SCS scenario for slots 16-21. A first mapping 732 shows how the OCC codewords are mapped to the slots for the UE 120b, a second mapping 734 shows how the OCC codewords are mapped to the slots for the UE 120c, and a third mapping 736 shows how the OCC codewords are mapped to the slots for the UE 120a.

In example 700D, n₀ mod M (for example, the constant) is equal to 0. UEs 120b and 120c may start NPUSCH transmissions from slot indexes that are multiples of M with n₀ mod M=0. For example, n₀ may equal 2 (because 2 mod 2=0). Furthermore, the length of NPUSCH transmissions for single-tone subcarrier 15 kHz may be an even quantity of slots because a minimum transmission length may be 16 slots and a multiple thereof. For example, the length of the NPUSCH transmission may be 32 slots for the UE 120b and 16 slots for the UE 120c.

Slots 738 are two slots that have been spread from one slot, as described above in connection with FIG. 2. As a result, two copies of each slot may be scaled accordingly for each UE 120b and 120c, and the OCC codewords corresponding to the slots 738 are aligned (for example, copies of slots generated by spreading are aligned in slots 738). Thus, signals transmitted by the UE 120b and the UE 120c in the slots 738 may be orthogonal to each other, and the network node 110 may successfully decode the signals.

As shown, the UE 120c may finish an NPUSCH transmission at the end of slot 17, and the UE 120a may start an NPUSCH transmission at the beginning of slot 20. The UE 120a may not start an NPUSCH transmission at the beginning of slot 19 (as discussed above in connection with FIG. 5B) because 19 is not a multiple of M=2 (and because 19 mod 2=1 does not equal the constant n₀ mod 2=0). Instead, the UE 120a may start an NPUSCH transmission at the beginning of slot 20 because slot 20 is the next slot having a slot index that is a multiple of M=2.

Slots 740 are two slots that have been spread from one slot, as described above in connection with FIG. 2. As a result, two copies of each slot may be scaled accordingly for each UE 120b and 120a, and the OCC codewords corresponding to the slots 740 are aligned (for example, copies of slots generated by spreading are aligned in slots 740). Thus, signals transmitted by the UE 120b and the UE 120a in the slots 740 may be orthogonal to each other, and the network node 110 may successfully decode the signals.

In some aspects (such as aspects for preventing DMRS pattern misalignment), the second integer multiple is two. For example, the slot index may be the first integer multiple of two of the OCC multiplexing factor, or the slot index modulo two of the OCC multiplexing factor may be equal to the constant. In some examples, K=2, and the slot index may be a multiple of 2M, or the slot index modulo 2M may be constant. In example 700E (discussed in greater detail below in connection with preventing DMRS pattern misalignment), the second integer multiple is two.

In some aspects, the slot index modulo two of the OCC multiplexing factor may be equal to the constant. For example, n₀ may be the first NB-IoT uplink slot that starts after the end of subframe n+k₀+K_{offset} for FDD, where n₀ modulo 2M is equal to the constant. In some aspects, the constant may be predefined. For example, the constant may be predefined in the wireless communication standard. In some aspects, the network node 110 may transmit, and the UE 120 may receive, an indication of the constant. For example, the constant may be configured via RRC or DCI, among other examples.

In some aspects, the slot index may be the first integer multiple of two of the OCC multiplexing factor. For example, n₀ may be the first NB-IoT uplink slot that is a multiple of 2M starting after the end of subframe n+k₀+K_{offset} for FDD. This example may correspond to n₀ modulo 2M (for example, the constant) being equal to zero.

With reference to FIG. 7E, in example 700E, the slot index is the first integer multiple of two of the OCC multiplexing factor. Example 700C illustrates TDM DMRS pattern alignment in symbol-wise OCC2 in a single-tone 3.75 kHz SCS scenario for slots 19-25. Each slot may include seven symbols (for example, OFDM symbols). For example, the slots may include an initial symbol allocated for DMRS and six subsequent symbols corresponding to respective OCC codewords, as discussed above in connection with FIG. 3. A first mapping 742 shows how the DMRS and OCC codewords are mapped to the symbols for the UE 120b, a second mapping 744 shows how the DMRS and OCC codewords are mapped to the symbols for the UE 120c, and a third mapping 746 shows how the DMRS and OCC codewords are mapped to the slots for a third UE (for example, the UE 120a).

In example 700E, n₀ mod 2M (for example, the constant) is equal to 0. UEs 120b and 120c may start NPUSCH transmissions from slot indexes that are multiples of 2M with n₀ mod 2M=0. For example, n₀ may equal 4 (because 4 mod 4=0). Furthermore, the length of NPUSCH transmissions for single-tone subcarrier 3.75 kHz may be an even quantity of slots because a minimum transmission length may be 16 slots and a multiple thereof. For example, the length of the NPUSCH transmission may be 32 slots for the UE 120b and 16 slots for the UE 120c.

Symbols 748 are two symbols that have been spread from one symbol, as described above in connection with FIG. 2. As a result, two copies of each symbol may be scaled accordingly for each UE 120b and 120c, and the OCC codewords corresponding to the symbols 748 are aligned (for example, copies of symbols generated by spreading are aligned in symbols 748). Thus, signals transmitted by the UE 120b and the UE 120c in the symbols 748 may be orthogonal to each other, and the network node 110 may successfully decode the signals.

As shown, the UE 120c may finish an NPUSCH transmission at the end of slot 19, and the UE 120a may start an NPUSCH transmission at the beginning of slot 24. The UE 120a may not start an NPUSCH transmission at the beginning of slot 21 (as discussed above in connection with FIG. 5C) because 21 is not a multiple of 2M=4 (and because 21 mod 4=1 does not equal the constant n₀ mod 2M=0). Instead, the UE 120a may start an NPUSCH transmission at the beginning of slot 24 because slot 24 is the next slot having a slot index that is a multiple of 2M=4 (for example, 24 mod 2M=0). In symbol 748 (which is the initial symbol in slot 24) and symbol 750 (which is the initial symbol in slot 25), the UE 120b may transmit a DMRS and the UE 120a may refrain from transmitting a DMRS; thus, the DMRS transmitted by the UE 120a may be received by the network node 110 correctly.

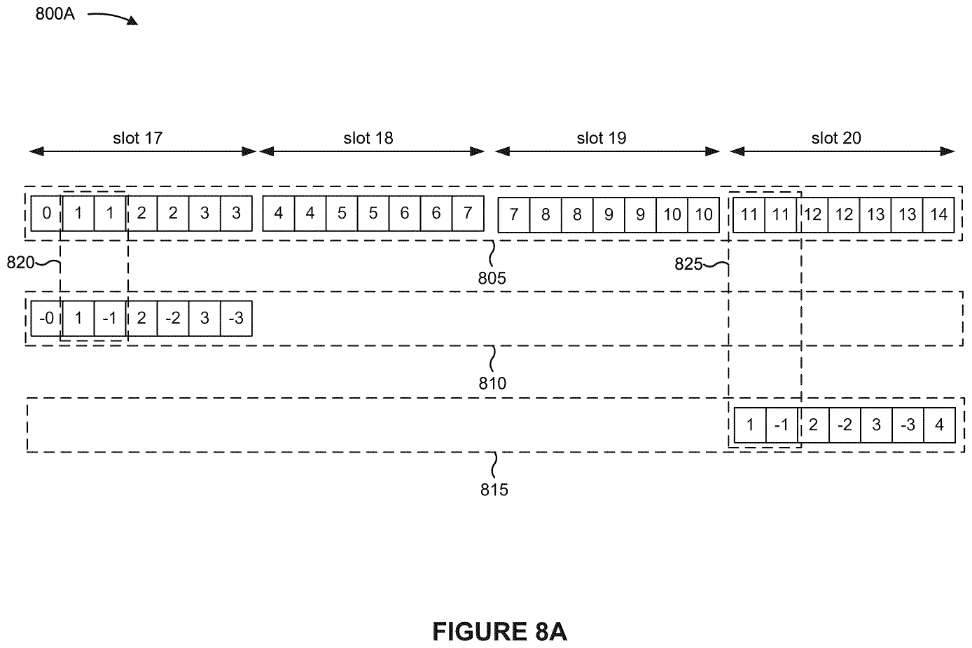

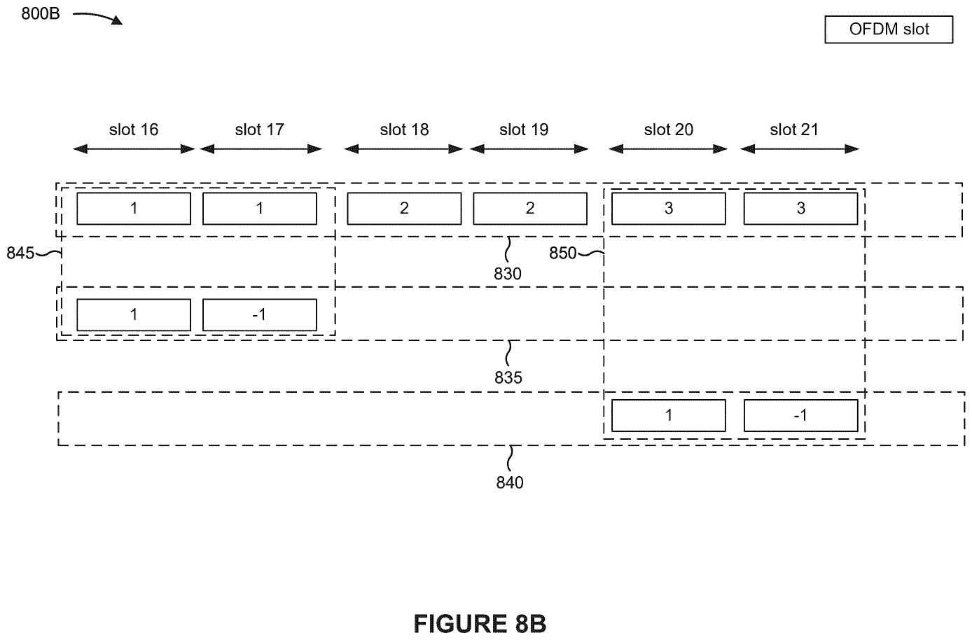

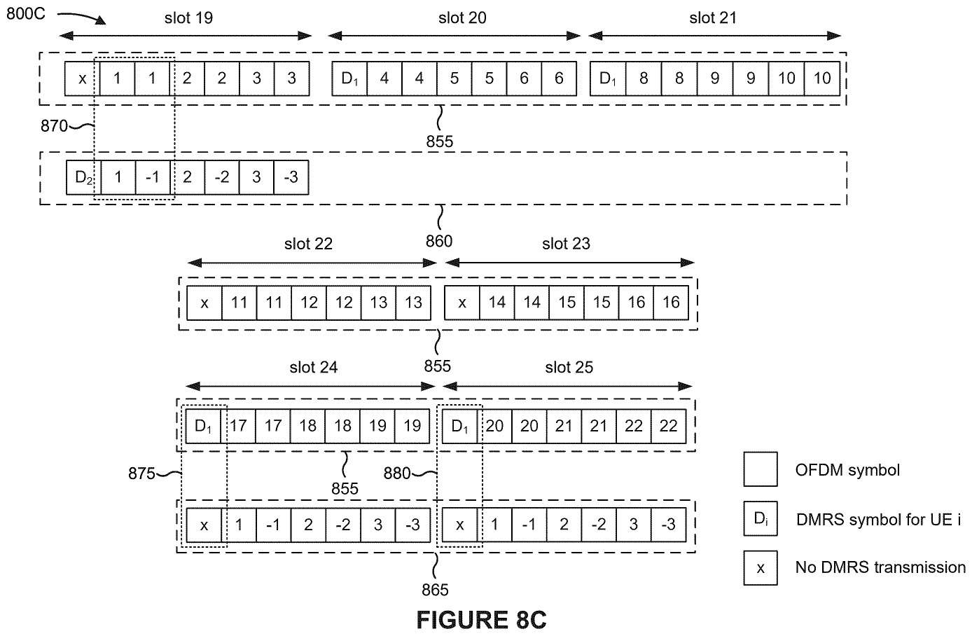

FIGS. 8A-8C are diagrams illustrating examples 800A-800C associated with second aspects for OCC-multiplexing-factor-based narrowband uplink communication times.

In some aspects, the network node 110 may transmit, and the UE 120 may receive, an indication of a scheduling delay offset (for example, k₀) in accordance with the OCC multiplexing factor. The UE 120 may transmit, and the network node 110 may receive, the narrowband uplink communication at the time (for example, n₀) in accordance with the scheduling delay offset. For example, the network node 110 may select a value of k₀ that translates to a value of n₀ such that one or more of OCC codeword misalignment or DMRS pattern misalignment are avoided. For example, the network node 110 may select a value of k₀ that makes a value of n₀ equal to a multiple of M (which may address OCC codeword misalignment) or a multiple of 2M (which may address DMRS pattern misalignment). In some examples, the network node 110 may select the value of k₀ using information regarding all UEs performing OCC, such as transmission start and end times. k₀ may be an appropriate parameter for mitigating misalignments because, unlike K_{offset} (which may be updated semi-statically), k₀ may be UE-specific.

In some aspects, the indication may comprise DCI (for example, UE-specific DCI). For example, the network node 110 may transmit, and the UE 120 may receive, DCI that indicates a value of k₀. The value of k₀ may be more than four possible values, unlike the value of k₀ shown in Tables 1 and 2 above in connection with FIG. 4. In some examples, the DCI may indicate the value of k₀ using repurposed or additional bits. For example, the DCI payload may increase (for example, the bitwidth of the k₀ field in the DCI may be greater than two, which may enable more than four possible value of k₀), or the DCI may have a DCI format that is suitable for carrying any possible value of k₀ (such as a DCI format other than the DCI format NO discussed above in connection with FIG. 4), among other examples.

With reference to FIG. 8A, example 800A illustrates OCC codeword alignment in symbol-wise OCC2 in a single-tone 3.75 kHz SCS scenario for slots 17-20. Each slot may include seven symbols (for example, OFDM symbols), each corresponding to respective OCC codewords. A first mapping 805 shows how the OCC codewords are mapped to the symbols for the UE 120b, a second mapping 810 shows how the OCC codewords are mapped to the symbols for the UE 120c, and a third mapping 815 shows how the OCC codewords are mapped to the symbols for the UE 120a.

UEs 120b and 120c may start NPUSCH transmissions from slot 2, for example. The length of NPUSCH transmissions for single-tone subcarrier 3.75 kHz may be an even quantity of slots because a minimum transmission length may be 16 slots and a multiple thereof. For example, the length of the NPUSCH transmission may be 32 slots for the UE 120b and 16 slots for the UE 120c.

Symbols 820 are two symbols that have been spread from one symbol, as described above in connection with FIG. 2. As a result, two copies of each symbol may be scaled accordingly for each UE 120b and 120c, and the OCC codewords corresponding to the symbols 820 are aligned (for example, copies of symbols generated by spreading are aligned in symbols 820). Thus, signals transmitted by the UE 120b and the UE 120c in the symbols 820 may be orthogonal to each other, and the network node 110 may successfully decode the signals.

As shown, the UE 120c may finish an NPUSCH transmission at the end of slot 17, and the UE 120a may start an NPUSCH transmission at the beginning of slot 20. The UE 120a may not start an NPUSCH transmission at the beginning of slot 19 (as discussed above in connection with FIG. 5A) because doing so would cause OCC codeword misalignment. Instead, the network node 110 may select a value of k₀ for UE 120a such that the resulting value of n₀ avoids OCC codeword misalignment. For example, the selected value of k₀ may cause the UE 120a to start an NPUSCH transmission at the beginning of slot 20.

Symbols 825 are two symbols that have been spread from one symbol, as described above in connection with FIG. 2. As a result, two copies of each symbol may be scaled accordingly for each UE 120b and 120a, and the OCC codewords corresponding to the symbols 825 are aligned (for example, copies of symbols generated by spreading are aligned in symbols 825). Thus, signals transmitted by the UE 120b and the UE 120a in the symbols 825 may be orthogonal to each other, and the network node 110 may successfully decode the signals.

With reference to FIG. 8B, example 800B illustrates OCC codeword misalignment in slot-wise OCC2 in a single-tone 15 kHz SCS scenario for slots 16-21. A first mapping 830 shows how the OCC codewords are mapped to the slots for the UE 120b, a second mapping 835 shows how the OCC codewords are mapped to the slots for the UE 120c, and a third mapping 840 shows how the OCC codewords are mapped to the slots for the UE 120a.

UEs 120b and 120c may start NPUSCH transmissions from slot 2, for example. The length of NPUSCH transmissions for single-tone subcarrier 15 kHz may be an even quantity of slots because a minimum transmission length may be 16 slots and a multiple thereof. For example, the length of the NPUSCH transmission may be 32 slots for the UE 120b and 16 slots for the UE 120c.

Slots 845 are two slots that have been spread from one slot, as described above in connection with FIG. 2. As a result, two copies of each slot may be scaled accordingly for each UE 120b and 120c, and the OCC codewords corresponding to the slots 845 are aligned (for example, copies of slots generated by spreading are aligned in slots 845). Thus, signals transmitted by the UE 120b and the UE 120c in the slots 845 may be orthogonal to each other, and the network node 110 may successfully decode the signals.

As shown, the UE 120c may finish an NPUSCH transmission at the end of slot 17, and the UE 120a may start an NPUSCH transmission at the beginning of slot 20. The UE 120a may not start an NPUSCH transmission at the beginning of slot 19 (as discussed above in connection with FIG. 5B) because doing so would cause OCC codeword misalignment. Instead, the network node 110 may select a value of k₀ for UE 120a such that the resulting value of n₀ avoids OCC codeword misalignment. For example, the selected value of k₀ may cause the UE 120a to start an NPUSCH transmission at the beginning of slot 20.

Slots 850 are two slots that have been spread from one slot, as described above in connection with FIG. 2. As a result, two copies of each slot may be scaled accordingly for each UE 120b and 120a, and the OCC codewords corresponding to the slots 850 are aligned (for example, copies of slots generated by spreading are aligned in slots 850). Thus, signals transmitted by the UE 120b and the UE 120a in the slots 850 may be orthogonal to each other, and the network node 110 may successfully decode the signals.

With reference to FIG. 8C, example 800C illustrates TDM DMRS pattern alignment in symbol-wise OCC2 in a single-tone 3.75 kHz SCS scenario for slots 19-25. Each slot may include seven symbols (for example, OFDM symbols). For example, the slots may include an initial symbol allocated for DMRS and six subsequent symbols corresponding to respective OCC codewords, as discussed above in connection with FIG. 3. A first mapping 855 shows how the DMRS and OCC codewords are mapped to the symbols for the UE 120b, a second mapping 860 shows how the DMRS and OCC codewords are mapped to the symbols for the UE 120c, and a third mapping 865 shows how the DMRS and OCC codewords are mapped to the slots for a third UE (for example, the UE 120a).

UEs 120b and 120c may start NPUSCH transmissions from slot 4, for example. The length of NPUSCH transmissions for single-tone subcarrier 3.75 kHz may be an even quantity of slots because a minimum transmission length may be 16 slots and a multiple thereof. For example, the length of the NPUSCH transmission may be 32 slots for the UE 120b and 16 slots for the UE 120c.

Symbols 870 are two symbols that have been spread from one symbol, as described above in connection with FIG. 2. As a result, two copies of each symbol may be scaled accordingly for each UE 120b and 120c, and the OCC codewords corresponding to the symbols 870 are aligned (for example, copies of symbols generated by spreading are aligned in symbols 870). Thus, signals transmitted by the UE 120b and the UE 120c in the symbols 870 may be orthogonal to each other, and the network node 110 may successfully decode the signals.

As shown, the UE 120c may finish an NPUSCH transmission at the end of slot 19, and the UE 120a may start an NPUSCH transmission at the beginning of slot 24. The UE 120a may not start an NPUSCH transmission at the beginning of slot 21 (as discussed above in connection with FIG. 5B) because doing so would cause DMRS pattern misalignment. Instead, the network node 110 may select a value of k₀ for UE 120a such that the resulting value of n₀ avoids DMRS pattern misalignment. For example, the selected value of k₀ may cause the UE 120a to start an NPUSCH transmission at the beginning of slot 24. In symbol 875 (which is the initial symbol in slot 24) and symbol 880 (which is the initial symbol in slot 25), the UE 120b may transmit a DMRS and the UE 120a may refrain from transmitting a DMRS; thus, the DMRS transmitted by the UE 120a may be received by the network node 110 correctly.

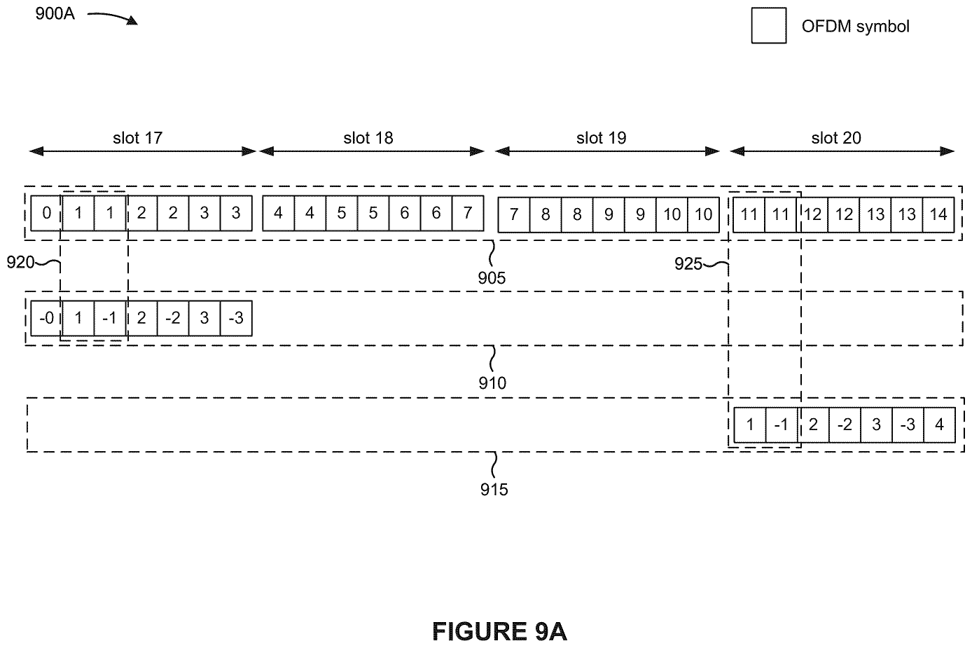

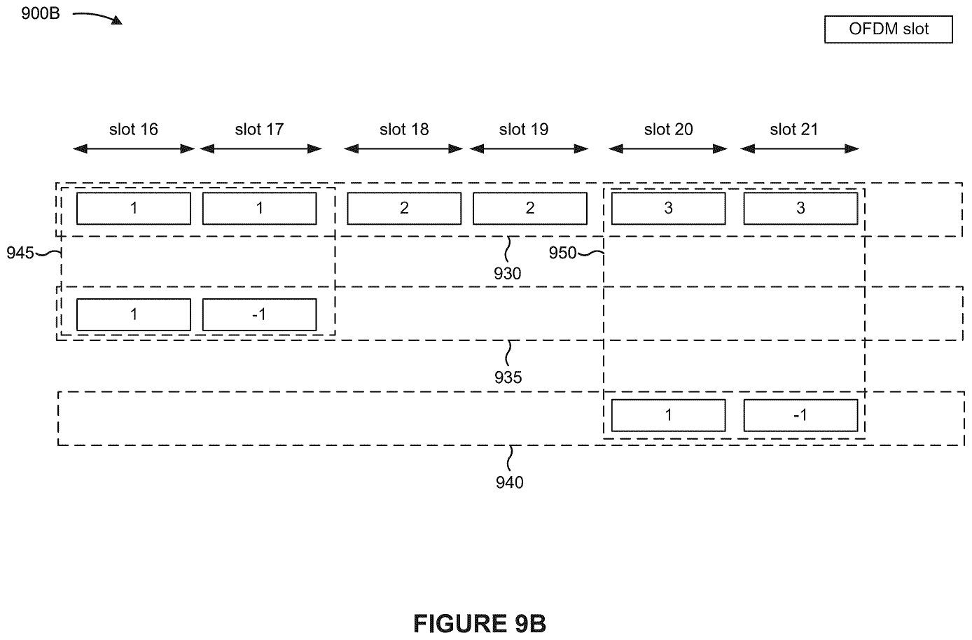

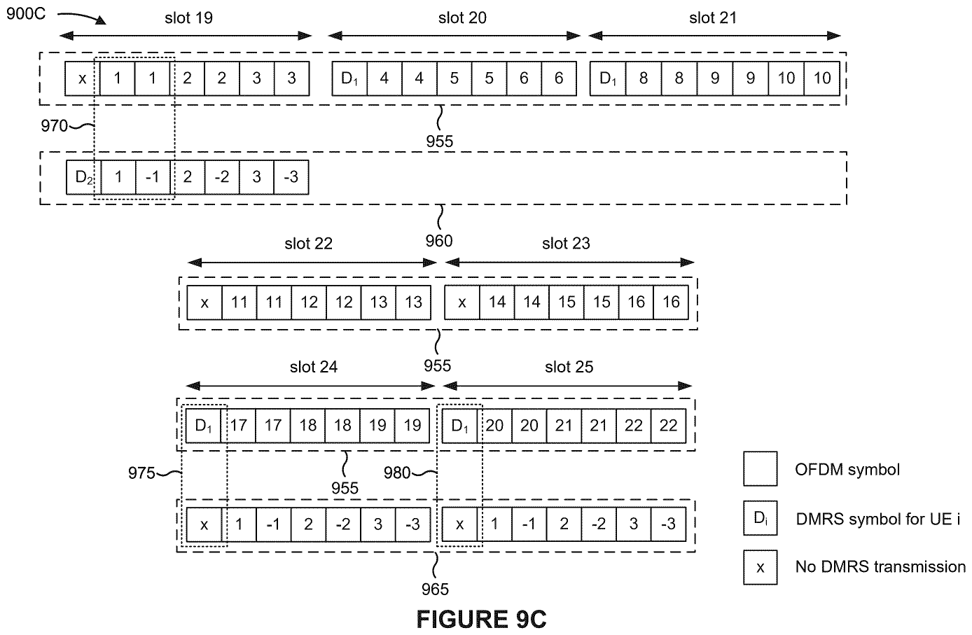

FIGS. 9A-9C are diagrams illustrating examples 900A-900C associated with third aspects for OCC-multiplexing-factor-based narrowband uplink communication times.

In some aspects, the network node 110 may transmit, and the UE 120 may receive, in accordance with the OCC multiplexing factor, an indication of an alignment offset that is equal to an integer value between zero and an integer multiple of the OCC multiplexing factor less one, inclusive. For example, the alignment offset may be referred to as k_{0-OCC}, and may be equal to any integer value from 0 to K×M−1, where K is the integer multiple. The value of K may be predefined in a wireless communication standard or configured via RRC or DCI, among other examples.

The UE 120 may transmit, and the network node 110 may receive, the narrowband uplink communication at the time (for example, no) in accordance with the alignment offset. In some examples, the time n₀ may be the first NB-IoT uplink slot starting after the end of subframe n+k₀+k_{0-OCC}+K_{offset}. The network node 110 may select a value of k_{0-OCC} that translates to a value of n₀ such that one or more of OCC codeword misalignment or DMRS pattern misalignment are avoided. For example, the network node 110 may select a value of k_{0-OCC} that makes a value of n₀ address OCC codeword misalignment or DMRS pattern misalignment. Thus, the network node 110 may use k_{0-OCC} to control OCC codeword alignment or DMRS pattern alignment. For example, if OCC for NPUSCH is enabled, then n₀ may be the first NB-IoT uplink slot starting after the end of subframe n+k₀+k_{0-OCC}+K_{offset} for FDD; otherwise, n₀ may be the first NB-IoT uplink slot starting after the end of subframe n+k₀+K_{offset} for FDD. In some examples, the network node 110 may select the value of k_{0-OCC} using information regarding all UEs performing OCC, such as transmission start and end times.

In some aspects (such as aspects for preventing OCC codeword misalignment), the integer multiple may be one (for example, K=1). For example, the alignment offset may be equal to an integer value between zero and the OCC multiplexing factor less one, inclusive. In examples 900A and 900B (discussed in greater detail below in connection with preventing OCC codeword misalignment), the second integer multiple is one.

In some aspects (for example, where the integer multiple is one), the indication may comprise DCI (for example, UE-specific DCI). For example, the network node 110 may transmit, and the UE 120 may receive, DCI that indicates a value of k_{0-OCC}. In some examples, the DCI may indicate the value of k_{0-OCC} using repurposed or additional bits. For example, the DCI payload may increase, or the DCI may have a DCI format that is suitable for carrying any possible value of k₀ (such as a DCI format other than the DCI format N0 discussed above in connection with FIG. 4), among other examples.

In some aspects (for example, where the integer multiple is one), the indication may comprise an alignment offset index that corresponds to the alignment offset in accordance with a mapping. The alignment offset index may be denoted by I_{delay-OCC}. The mapping may correlate values of the alignment offset index and values of k_{0-OCC}. In some examples, the possible values of k_{0-OCC} may be 0 to M−1, inclusive. For example, the value of k_{0-OCC} may be set to 0 for UEs that do not perform OCC, UEs that cannot perform aspects described herein relating to alignment, or UEs that perform OCC and avoid misalignment without implementing aspects described herein relating to alignment. In some examples, a total quantity of bits used to represent the value of k_{0-OCC} may be log₂M. Thus, a bitwidth in an alignment offset index field of DCI may be log₂M. In some aspects, the mapping may be predefined. For example, the constant may be predefined in the wireless communication standard. In some aspects, the network node 110 may transmit, and the UE 120 may receive, an RRC configuration of the mapping. For example, the constant may be configured via RRC, among other examples. Table 3 below illustrates an example mapping.

TABLE 3

| I_{delay-OCC} | k_{0-OCC} |
|---|---|
| 0 | 0 |
| 1 | 1 |

. . .

| | |
|---|---|
| M − 1 | M − 1 |

With reference to FIG. 9A, example 900A illustrates OCC codeword alignment in symbol-wise OCC2 in a single-tone 3.75 kHz SCS scenario for slots 17-20. Each slot may include seven symbols (for example, OFDM symbols), each corresponding to respective OCC codewords. A first mapping 905 shows how the OCC codewords are mapped to the symbols for the UE 120b, a second mapping 910 shows how the OCC codewords are mapped to the symbols for the UE 120c, and a third mapping 915 shows how the OCC codewords are mapped to the symbols for the UE 120a.

UEs 120b and 120c may start NPUSCH transmissions from slot 2, for example. The length of NPUSCH transmissions for single-tone subcarrier 3.75 kHz may be an even quantity of slots because a minimum transmission length may be 16 slots and a multiple thereof. For example, the length of the NPUSCH transmission may be 32 slots for the UE 120b and 16 slots for the UE 120c.

Symbols 920 are two symbols that have been spread from one symbol, as described above in connection with FIG. 2. As a result, two copies of each symbol may be scaled accordingly for each UE 120b and 120c, and the OCC codewords corresponding to the symbols 920 are aligned (for example, copies of symbols generated by spreading are aligned in symbols 920). Thus, signals transmitted by the UE 120b and the UE 120c in the symbols 920 may be orthogonal to each other, and the network node 110 may successfully decode the signals.

As shown, the UE 120c may finish an NPUSCH transmission at the end of slot 17, and the UE 120a may start an NPUSCH transmission at the beginning of slot 20. The UE 120a may not start an NPUSCH transmission at the beginning of slot 19 (as discussed above in connection with FIG. 5A) because doing so would cause OCC codeword misalignment. Instead, the network node 110 may select a value of I_{delay-OCC} or k_{0-OCC} for UE 120a such that the resulting value of n₀ avoids OCC codeword misalignment. For example, the selected value of I_{delay-OCC} or k_{0-OCC} may be 1, which may cause the UE 120a to delay transmission by 1 slot and start an NPUSCH transmission at the beginning of slot 20.

Symbols 925 are two symbols that have been spread from one symbol, as described above in connection with FIG. 2. As a result, two copies of each symbol may be scaled accordingly for each UE 120b and 120a, and the OCC codewords corresponding to the symbols 925 are aligned (for example, copies of symbols generated by spreading are aligned in symbols 925). Thus, signals transmitted by the UE 120b and the UE 120a in the symbols 925 may be orthogonal to each other, and the network node 110 may successfully decode the signals.

With reference to FIG. 9B, example 900B illustrates OCC codeword misalignment in slot-wise OCC2 in a single-tone 15 kHz SCS scenario for slots 16-21. A first mapping 930 shows how the OCC codewords are mapped to the slots for the UE 120b, a second mapping 935 shows how the OCC codewords are mapped to the slots for the UE 120c, and a third mapping 940 shows how the OCC codewords are mapped to the slots for the UE 120a.

UEs 120b and 120c may start NPUSCH transmissions from slot 2, for example. The length of NPUSCH transmissions for single-tone subcarrier 15 kHz may be an even quantity of slots because a minimum transmission length may be 16 slots and a multiple thereof. For example, the length of the NPUSCH transmission may be 32 slots for the UE 120b and 16 slots for the UE 120c.

Slots 945 are two slots that have been spread from one slot, as described above in connection with FIG. 2. As a result, two copies of each slot may be scaled accordingly for each UE 120b and 120c, and the OCC codewords corresponding to the slots 945 are aligned (for example, copies of slots generated by spreading are aligned in slots 945). Thus, signals transmitted by the UE 120b and the UE 120c in the slots 945 may be orthogonal to each other, and the network node 110 may successfully decode the signals.

As shown, the UE 120c may finish an NPUSCH transmission at the end of slot 17, and the UE 120a may start an NPUSCH transmission at the beginning of slot 20. The UE 120a may not start an NPUSCH transmission at the beginning of slot 19 (as discussed above in connection with FIG. 5B) because doing so would cause OCC codeword misalignment. Instead, the network node 110 may select a value of I_{delay-OCC} or k_{0-OCC} for UE 120a such that the resulting value of n₀ avoids OCC codeword misalignment. For example, the selected value of I_{delay-OCC} or k_{0-OCC} may be 1, which may cause the UE 120a to delay transmission by 1 slot and start an NPUSCH transmission at the beginning of slot 20.

Slots 950 are two slots that have been spread from one slot, as described above in connection with FIG. 2. As a result, two copies of each slot may be scaled accordingly for each UE 120b and 120a, and the OCC codewords corresponding to the slots 950 are aligned (for example, copies of slots generated by spreading are aligned in slots 950). Thus, signals transmitted by the UE 120b and the UE 120a in the slots 950 may be orthogonal to each other, and the network node 110 may successfully decode the signals.

In some aspects (such as aspects for preventing DMRS pattern misalignment), the integer multiple may be two (for example, K=2). For example, the alignment offset may be equal to an integer value between zero and the two of the OCC multiplexing factor less one, inclusive. In example 900C (discussed in greater detail below in connection with preventing DMRS pattern misalignment), the second integer multiple is two.

In some aspects (for example, where the integer multiple is two), the indication may comprise DCI (for example, UE-specific DCI). For example, the network node 110 may transmit, and the UE 120 may receive, DCI that indicates a value of k_{0-OCC}. In some examples, the DCI may indicate the value of k_{0-OCC} using repurposed or additional bits. For example, the DCI payload may increase, or the DCI may have a DCI format that is suitable for carrying any possible value of k₀ (such as a DCI format other than the DCI format NO discussed above in connection with FIG. 4), among other examples.

In some aspects (for example, where the integer multiple is two), the indication may comprise an alignment offset index (for example, I_{delay-OCC}) that corresponds to the alignment offset in accordance with a mapping. The mapping may correlate values of the alignment offset index and values of k_{0-OCC}. In some examples, the possible values of k_{0-OCC} may be 0 to 2M−1, inclusive. For example, the value of k_{0-OCC} may be set to 0 for UEs that do not perform OCC, UEs that cannot perform aspects described herein relating to alignment, or UEs that perform OCC and avoid misalignment without implementing aspects described herein relating to alignment. In some examples, a total quantity of bits used to represent the value of k_{0-OCC} may be log₂2M. Thus, a bitwidth in an alignment offset index field of DCI may be log₂2M. In some aspects, the mapping may be predefined. For example, the constant may be predefined in the wireless communication standard. In some aspects, the network node 110 may transmit, and the UE 120 may receive, an RRC configuration of the mapping. For example, the constant may be configured via RRC, among other examples. Table 4 below illustrates an example mapping.

TABLE 4

| I_{delay-OCC} | k_{0-OCC} |
|---|---|
| 0 | 0 |
| 1 | 1 |

. . .

| | |
|---|---|
| 2M − 1 | 2M − 1 |

With reference to FIG. 9C, example 900C illustrates TDM DMRS alignment in symbol-wise OCC2 in a single-tone 3.75 kHz SCS scenario for slots 19-25. Each slot may include seven symbols (for example, OFDM symbols). For example, the slots may include an initial symbol allocated for DMRS and six subsequent symbols corresponding to respective OCC codewords, as discussed above in connection with FIG. 3. A first mapping 955 shows how the DMRS and OCC codewords are mapped to the symbols for the UE 120b, a second mapping 960 shows how the DMRS and OCC codewords are mapped to the symbols for the UE 120c, and a third mapping 965 shows how the DMRS and OCC codewords are mapped to the slots for a third UE (for example, the UE 120a).

UEs 120b and 120c may start NPUSCH transmissions from slot 4, for example. The length of NPUSCH transmissions for single-tone subcarrier 3.75 kHz may be an even quantity of slots because a minimum transmission length may be 16 slots and a multiple thereof. For example, the length of the NPUSCH transmission may be 32 slots for the UE 120b and 16 slots for the UE 120c.

Symbols 970 are two symbols that have been spread from one symbol, as described above in connection with FIG. 2. As a result, two copies of each symbol may be scaled accordingly for each UE 120b and 120c, and the OCC codewords corresponding to the symbols 970 are aligned (for example, copies of symbols generated by spreading are aligned in symbols 970). Thus, signals transmitted by the UE 120b and the UE 120c in the symbols 970 may be orthogonal to each other, and the network node 110 may successfully decode the signals.

As shown, the UE 120c may finish an NPUSCH transmission at the end of slot 19, and the UE 120a may start an NPUSCH transmission at the beginning of slot 24. The UE 120a may not start an NPUSCH transmission at the beginning of slot 21 (as discussed above in connection with FIG. 5B) because doing so would cause DMRS pattern misalignment. Instead, the network node 110 may select a value of I_{delay-OCC} Or k_{0-OCC} for UE 120a such that the resulting value of n₀ avoids DMRS pattern misalignment. For example, the selected value of I_{delay-OCC} or k_{0-OCC} may be 3, which may cause the UE 120a to delay transmission by 3 slot and start an NPUSCH transmission at the beginning of slot 24. In symbol 975 (which is the initial symbol in slot 24) and symbol 980 (which is the initial symbol in slot 25), the UE 120b may transmit a DMRS and the UE 120a may refrain from transmitting a DMRS; thus, the DMRS transmitted by the UE 120a may be received by the network node 110 correctly.

Transmitting or receiving the narrowband uplink communication at a time in accordance with the OCC multiplexing factor may help to prevent one or more of OCC codeword misalignment or DMRS pattern misalignment, thereby improving one or more of performance or capacity. For example, aligning OCC codewords may enable the network node 110 to decode multiplexed NPUSCH communications, thereby exploiting capacity gains offered by OCC. Additionally or alternatively, aligning DMRS patterns may help to ensure that a single DMRS per UE is transmitted per DMRS symbol, thereby improving one or more of channel estimation or carrier frequency offset estimation, and thus, increasing performance.

The slot index being a first integer multiple of a second integer multiple of the OCC multiplexing factor, or the slot index modulo the second integer multiple of the OCC multiplexing factor being equal to the constant, may introduce little or no signaling overhead between the UE 120 and the network node 110. For example, the UE 120 and the network node 110 may identify the NB-IoT uplink slot n₀ using K and M.

Transmitting or receiving the indication of the scheduling delay offset in accordance with the OCC multiplexing factor may introduce little or n₀ UE-side complexity because the network node 110 may be responsible for identifying the value of k₀.

Transmitting or receiving, in accordance with the OCC multiplexing factor, an indication of an alignment offset that is equal to an integer value between zero and an integer multiple of the OCC multiplexing factor less one, inclusive, may introduce little signaling overhead between the UE 120 and the network node 110 and little or no UE-side complexity. Little signaling overhead may be introduced because k_{0-OCC} may occupy only log₂ (KM) bits, and little or no UE-side complexity because the network node 110 may be responsible for identifying the value of k_{0-OCC}.

FIG. 10 is a flowchart illustrating an example process 1000 performed, for example, at a UE or an apparatus of a UE that supports narrowband uplink communication times in accordance with an OCC multiplexing factor. Example process 1000 is an example where the apparatus or the UE (for example, UE 120) performs operations associated with narrowband uplink communication times in accordance with an OCC multiplexing factor.

As shown in FIG. 10, in some aspects, process 1000 may include transmitting a UE capability indication associated with multiplexing (block 1010). For example, the UE (such as by using communication manager 1206 or transmission component 1204, depicted in FIG. 12) may transmit a UE capability indication associated with multiplexing, as described above, such as in connection with operation 610 of FIG. 6.

As further shown in FIG. 10, in some aspects, process 1000 may include receiving, in accordance with the UE capability indication, an indication of an OCC multiplexing factor (block 1020). For example, the UE (such as by using communication manager 1206 or reception component 1202, depicted in FIG. 12) may receive, in accordance with the UE capability indication, an indication of an OCC multiplexing factor, as described above, such as in connection with operation 620 of FIG. 6.

As further shown in FIG. 10, in some aspects, process 1000 may include transmitting a narrowband uplink communication at a time in accordance with the OCC multiplexing factor (block 1030). For example, the UE (such as by using communication manager 1206 or transmission component 1204, depicted in FIG. 12) may transmit a narrowband uplink communication at a time in accordance with the OCC multiplexing factor, as described above, such as in connection with operation 630 and FIG. 6.

Process 1000 may include additional aspects, such as any single aspect or any combination of aspects described below or in connection with one or more other processes described elsewhere herein.

In a first additional aspect, a slot index associated with the time is a first integer multiple of a second integer multiple of the OCC multiplexing factor, or the slot index modulo the second integer multiple of the OCC multiplexing factor is equal to a constant across UEs associated with the OCC multiplexing factor.

In a second additional aspect, alone or in combination with the first aspect, the second integer multiple is one.

In a third additional aspect, alone or in combination with one or more of the first and second aspects, the slot index modulo the OCC multiplexing factor is equal to the constant.

In a fourth additional aspect, alone or in combination with one or more of the first through third aspects, the constant is predefined.

In a fifth additional aspect, alone or in combination with one or more of the first through fourth aspects, process 1000 includes receiving an indication of the constant.

In a sixth additional aspect, alone or in combination with one or more of the first through fifth aspects, the slot index is the first integer multiple of the OCC multiplexing factor.

In a seventh additional aspect, alone or in combination with one or more of the first through sixth aspects, the second integer multiple is two.

In an eighth additional aspect, alone or in combination with one or more of the first through seventh aspects, the slot index modulo two of the OCC multiplexing factor is equal to the constant.

In a ninth additional aspect, alone or in combination with one or more of the first through eighth aspects, the constant is predefined.

In a tenth additional aspect, alone or in combination with one or more of the first through ninth aspects, process 1000 includes receiving an indication of the constant.

In an eleventh additional aspect, alone or in combination with one or more of the first through tenth aspects, the slot index is the first integer multiple of two of the OCC multiplexing factor.

In a twelfth additional aspect, alone or in combination with one or more of the first through eleventh aspects, process 1000 includes receiving an indication of a scheduling delay offset in accordance with the OCC multiplexing factor, and transmitting the narrowband uplink communication at the time includes transmitting the narrowband uplink communication at the time in accordance with the scheduling delay offset.

In a thirteenth additional aspect, alone or in combination with one or more of the first through twelfth aspects, the indication of the scheduling delay offset comprises DCI.

In a fourteenth additional aspect, alone or in combination with one or more of the first through thirteenth aspects, process 1000 includes receiving, in accordance with the OCC multiplexing factor, an indication of an alignment offset that is equal to an integer value between zero and an integer multiple of the OCC multiplexing factor less one, inclusive, and transmitting the narrowband uplink communication at the time includes transmitting the narrowband uplink communication at the time in accordance with the alignment offset.

In a fifteenth additional aspect, alone or in combination with one or more of the first through fourteenth aspects, the integer multiple is one.

In a sixteenth additional aspect, alone or in combination with one or more of the first through fifteenth aspects, the indication of the alignment offset comprises DCI.

In a seventeenth additional aspect, alone or in combination with one or more of the first through sixteenth aspects, the indication of the alignment offset comprises an alignment offset index that corresponds to the alignment offset in accordance with a mapping.

In an eighteenth additional aspect, alone or in combination with one or more of the first through seventeenth aspects, the mapping is predefined.

In a nineteenth additional aspect, alone or in combination with one or more of the first through eighteenth aspects, process 1000 includes receiving an RRC configuration of the mapping.

In a twentieth additional aspect, alone or in combination with one or more of the first through nineteenth aspects, the integer multiple is two.

In a twenty-first additional aspect, alone or in combination with one or more of the first through twentieth aspects, the indication of the alignment offset comprises DCI.

In a twenty-second additional aspect, alone or in combination with one or more of the first through twenty-first aspects, the indication of the alignment offset comprises an alignment offset index that corresponds to the alignment offset in accordance with a mapping.

In a twenty-third additional aspect, alone or in combination with one or more of the first through twenty-second aspects, the mapping is predefined.

In a twenty-fourth additional aspect, alone or in combination with one or more of the first through twenty-third aspects, process 1000 includes receiving an RRC configuration of the mapping.

Although FIG. 10 shows example blocks of process 1000, in some aspects, process 1000 may include additional blocks, fewer blocks, different blocks, or differently arranged blocks than those depicted in FIG. 10. Additionally or alternatively, two or more of the blocks of process 1000 may be performed in parallel.

FIG. 11 is a flowchart illustrating an example process 1100 performed, for example, at a network node or an apparatus of a network node that supports narrowband uplink communication times in accordance with an OCC multiplexing factor. Example process 1100 is an example where the apparatus or the network node (for example, network node 110) performs operations associated with narrowband uplink communication times in accordance with an OCC multiplexing factor.

As shown in FIG. 11, in some aspects, process 1100 may include receiving a UE capability indication associated with multiplexing (block 1110). For example, the network node (such as by using communication manager 1306 or reception component 1302, depicted in FIG. 13) may receive a UE capability indication associated with multiplexing, as described above, such as in connection with operation 610 of FIG. 6.

As further shown in FIG. 11, in some aspects, process 1100 may include transmitting, in accordance with the UE capability indication, an indication of an OCC multiplexing factor (block 1120). For example, the network node (such as by using communication manager 1306 or transmission component 1304, depicted in FIG. 13) may transmit, in accordance with the UE capability indication, an indication of an OCC multiplexing factor, as described above, such as in connection with operation 620 of FIG. 6.

As further shown in FIG. 11, in some aspects, process 1100 may include receiving a narrowband uplink communication at a time in accordance with the OCC multiplexing factor (block 1130). For example, the network node (such as by using communication manager 1306 or reception component 1302, depicted in FIG. 13) may receive a narrowband uplink communication at a time in accordance with the OCC multiplexing factor, as described above, such as in connection with operation 630 of FIG. 6.

Process 1100 may include additional aspects, such as any single aspect or any combination of aspects described below or in connection with one or more other processes described elsewhere herein.

In a first additional aspect, a slot index associated with the time is a first integer multiple of a second integer multiple of the OCC multiplexing factor, or the slot index modulo the second integer multiple of the OCC multiplexing factor is equal to a constant across UEs associated with the OCC multiplexing factor.

In a second additional aspect, alone or in combination with the first aspect, the second integer multiple is one.

In a third additional aspect, alone or in combination with one or more of the first and second aspects, the slot index modulo the OCC multiplexing factor is equal to the constant.

In a fourth additional aspect, alone or in combination with one or more of the first through third aspects, the constant is predefined.

In a fifth additional aspect, alone or in combination with one or more of the first through fourth aspects, process 1100 includes transmitting an indication of the constant.

In a sixth additional aspect, alone or in combination with one or more of the first through fifth aspects, the slot index is the first integer multiple of the OCC multiplexing factor.

In a seventh additional aspect, alone or in combination with one or more of the first through sixth aspects, the second integer multiple is two.

In an eighth additional aspect, alone or in combination with one or more of the first through seventh aspects, the slot index modulo two of the OCC multiplexing factor is equal to the constant.

In a ninth additional aspect, alone or in combination with one or more of the first through eighth aspects, the constant is predefined.

In a tenth additional aspect, alone or in combination with one or more of the first through ninth aspects, process 1100 includes transmitting an indication of the constant.

In an eleventh additional aspect, alone or in combination with one or more of the first through tenth aspects, the slot index is the first integer multiple of two of the OCC multiplexing factor.

In a twelfth additional aspect, alone or in combination with one or more of the first through eleventh aspects, process 1100 includes transmitting an indication of a scheduling delay offset in accordance with the OCC multiplexing factor, and receiving the narrowband uplink communication at the time includes receiving the narrowband uplink communication at the time in accordance with the scheduling delay offset.

In a thirteenth additional aspect, alone or in combination with one or more of the first through twelfth aspects, the indication of the scheduling delay offset comprises DCI.

In a fourteenth additional aspect, alone or in combination with one or more of the first through thirteenth aspects, process 1100 includes transmitting, in accordance with the OCC multiplexing factor, an indication of an alignment offset that is equal to an integer value between zero and an integer multiple of the OCC multiplexing factor less one, inclusive, and receiving the narrowband uplink communication at the time includes receiving the narrowband uplink communication at the time in accordance with the alignment offset.

In a fifteenth additional aspect, alone or in combination with one or more of the first through fourteenth aspects, the integer multiple is one.

In a sixteenth additional aspect, alone or in combination with one or more of the first through fifteenth aspects, the indication of the alignment offset comprises DCI.

In a seventeenth additional aspect, alone or in combination with one or more of the first through sixteenth aspects, the indication of the alignment offset comprises an alignment offset index that corresponds to the alignment offset in accordance with a mapping.

In an eighteenth additional aspect, alone or in combination with one or more of the first through seventeenth aspects, the mapping is predefined.

In a nineteenth additional aspect, alone or in combination with one or more of the first through eighteenth aspects, process 1100 includes transmitting an RRC configuration of the mapping.

In a twentieth additional aspect, alone or in combination with one or more of the first through nineteenth aspects, the integer multiple is two.

In a twenty-first additional aspect, alone or in combination with one or more of the first through twentieth aspects, the indication of the alignment offset comprises DCI.

In a twenty-second additional aspect, alone or in combination with one or more of the first through twenty-first aspects, the indication of the alignment offset comprises an alignment offset index that corresponds to the alignment offset in accordance with a mapping.

In a twenty-third additional aspect, alone or in combination with one or more of the first through twenty-second aspects, the mapping is predefined.

In a twenty-fourth additional aspect, alone or in combination with one or more of the first through twenty-third aspects, process 1100 includes transmitting an RRC configuration of the mapping.

Although FIG. 11 shows example blocks of process 1100, in some aspects, process 1100 may include additional blocks, fewer blocks, different blocks, or differently arranged blocks than those depicted in FIG. 11. Additionally or alternatively, two or more of the blocks of process 1100 may be performed in parallel.

FIG. 12 is a diagram of an example apparatus 1200 for wireless communication that supports narrowband uplink communication times in accordance with an OCC multiplexing factor. The apparatus 1200 may be a UE, or a UE may include the apparatus 1200. In some aspects, the apparatus 1200 includes a reception component 1202, a transmission component 1204, and a communication manager 1206, which may be in communication with one another (for example, via one or more buses). As shown, the apparatus 1200 may communicate with another apparatus 1208 (such as a UE 120, a network node 110, or another wireless communication device) using the reception component 1202 and the transmission component 1204. The communication manager 1206 may be included in, or implemented via, a processing system (for example, the processing system 140). In some aspects, the communication manager 1206 is the communication manager 150

In some aspects, the apparatus 1200 may be configured to or operable to perform one or more operations described herein in connection with FIGS. 6-9C. Additionally or alternatively, the apparatus 1200 may be configured to or operable to perform one or more processes described herein, such as process 1000 of FIG. 10.

The reception component 1202 may receive communications, such as reference signals, control information, or data communications, from the apparatus 1208. The reception component 1202 may provide received communications to one or more other components of the apparatus 1200, such as the communication manager 1206. In some aspects, the reception component 1202 may perform signal processing on the received communications, and may provide the processed signals to the one or more other components in a similar manner as described above in connection with FIG. 1. In some aspects, the reception component 1202 may include one or more components of the UE described above in connection with FIG. 1, such as a radio, one or more RF chains, one or more transceivers, or one or more modems, each of which may in turn be coupled with one or more antennas of the UE.

The transmission component 1204 may transmit communications, such as reference signals, control information, or data communications, to the apparatus 1208. In some aspects, the communication manager 1206 may generate communications and may transmit the generated communications to the transmission component 1204 for transmission to the apparatus 1208. In some aspects, the transmission component 1204 may perform signal processing on the generated communications, and may transmit the processed signals to the apparatus 1208 in a similar manner as described above in connection with FIG. 1. In some aspects, the transmission component 1204 may include one or more components of the UE described above in connection with FIG. 1, such as a radio, one or more RF chains, one or more transceivers, or one or more modems, each of which may in turn be coupled with one or more antennas of the UE. In some aspects, the transmission component 1204 may be co-located with the reception component 1202.

The communication manager 1206 may transmit or may cause the transmission component 1204 to transmit a UE capability indication associated with multiplexing. The communication manager 1206 may receive or may cause the reception component 1202 to receive, in accordance with the UE capability indication, an indication of an OCC multiplexing factor. The communication manager 1206 may transmit or may cause the transmission component 1204 to transmit a narrowband uplink communication at a time in accordance with the OCC multiplexing factor. In some aspects, the communication manager 1206 may perform one or more operations described elsewhere herein as being performed by one or more components of the communication manager 1206.

The transmission component 1204 may transmit a UE capability indication associated with multiplexing. The reception component 1202 may receive, in accordance with the UE capability indication, an indication of an OCC multiplexing factor. The transmission component 1204 may transmit a narrowband uplink communication at a time in accordance with the OCC multiplexing factor. In some aspects, the reception component 1202 may receive an indication of the constant. In some aspects, the reception component 1202 may receive an indication of a scheduling delay offset in accordance with the OCC multiplexing factor. In some aspects, the reception component 1202 may receive, in accordance with the OCC multiplexing factor, an indication of an alignment offset that is equal to an integer value between zero and an integer multiple of the OCC multiplexing factor less one, inclusive. In some aspects, the reception component 1202 may receive an RRC configuration of the mapping.

The quantity and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally or alternatively, a set of (one or more) components shown in FIG. 12 may perform one or more functions described as being performed by another set of components shown in FIG. 12.

FIG. 13 is a diagram of an example apparatus 1300 for wireless communication that supports narrowband uplink communication times in accordance with an OCC multiplexing factor. The apparatus 1300 may be a network node, or a network node may include the apparatus 1300. In some aspects, the apparatus 1300 includes a reception component 1302, a transmission component 1304, and a communication manager 1306, which may be in communication with one another (for example, via one or more buses). As shown, the apparatus 1300 may communicate with another apparatus 1308 (such as a UE 120, a network node 110, or another wireless communication device) using the reception component 1302 and the transmission component 1304. The communication manager 1306 may be included in, or implemented via, a processing system (for example, the processing system 145). In some aspects, the communication manager 1306 is the communication manager 155

In some aspects, the apparatus 1300 may be configured to or operable to perform one or more operations described herein in connection with FIGS. 6-9C. Additionally or alternatively, the apparatus 1300 may be configured to or operable to perform one or more processes described herein, such as process 1100 of FIG. 11.

The reception component 1302 may receive communications, such as reference signals, control information, or data communications, from the apparatus 1308. The reception component 1302 may provide received communications to one or more other components of the apparatus 1300, such as the communication manager 1306. In some aspects, the reception component 1302 may perform signal processing on the received communications, and may provide the processed signals to the one or more other components in a similar manner as described above in connection with FIG. 1. In some aspects, the reception component 1302 may include one or more components of the network node described above in connection with FIG. 1, such as a radio, one or more RF chains, one or more transceivers, or one or more modems, each of which may in turn be coupled with one or more antennas of the network node.

The transmission component 1304 may transmit communications, such as reference signals, control information, or data communications, to the apparatus 1308. In some aspects, the communication manager 1306 may generate communications and may transmit the generated communications to the transmission component 1304 for transmission to the apparatus 1308. In some aspects, the transmission component 1304 may perform signal processing on the generated communications, and may transmit the processed signals to the apparatus 1308 in a similar manner as described above in connection with FIG. 1. In some aspects, the transmission component 1304 may include one or more components of the network node described above in connection with FIG. 1, such as a radio, one or more RF chains, one or more transceivers, or one or more modems, each of which may in turn be coupled with one or more antennas of the network node. In some aspects, the transmission component 1304 may be co-located with the reception component 1302.

The communication manager 1306 may receive or may cause the reception component 1302 to receive a UE capability indication associated with multiplexing. The communication manager 1306 may transmit or may cause the transmission component 1304 to transmit, in accordance with the UE capability indication, an indication of an OCC multiplexing factor. The communication manager 1306 may receive or may cause the reception component 1302 to receive a narrowband uplink communication at a time in accordance with the OCC multiplexing factor. In some aspects, the communication manager 1306 may perform one or more operations described elsewhere herein as being performed by one or more components of the communication manager 1306.

The reception component 1302 may receive a UE capability indication associated with multiplexing. The transmission component 1304 may transmit, in accordance with the UE capability indication, an indication of an OCC multiplexing factor. The reception component 1302 may receive a narrowband uplink communication at a time in accordance with the OCC multiplexing factor. In some aspects, the transmission component 1304 may transmit an indication of the constant. In some aspects, the transmission component 1304 may transmit an indication of a scheduling delay offset in accordance with the OCC multiplexing factor. In some aspects, the transmission component 1304 may transmit, in accordance with the OCC multiplexing factor, an indication of an alignment offset that is equal to an integer value between zero and an integer multiple of the OCC multiplexing factor less one, inclusive. In some aspects, the transmission component 1304 may transmit an RRC configuration of the mapping.

The quantity and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a user equipment (UE), comprising: transmitting a UE capability indication associated with multiplexing; receiving, in accordance with the UE capability indication, an indication of an orthogonal cover code (OCC) multiplexing factor; and transmitting a narrowband uplink communication at a time in accordance with the OCC multiplexing factor.

Aspect 2: The method of Aspect 1, wherein a slot index associated with the time is a first integer multiple of a second integer multiple of the OCC multiplexing factor, or the slot index modulo the second integer multiple of the OCC multiplexing factor is equal to a constant across UEs associated with the OCC multiplexing factor.

Aspect 3: The method of Aspect 2, wherein the second integer multiple is one or two.

Aspect 4: The method of Aspect 4, wherein the second integer multiple is one, the slot index modulo the OCC multiplexing factor is equal to the constant, and the constant is predefined.

Aspect 5: The method of Aspect 4, wherein the second integer multiple is one, and the slot index modulo the OCC multiplexing factor is equal to the constant, the method further comprising: receiving an indication of the constant.

Aspect 6: The method of Aspect 3, wherein the second integer multiple is two, the slot index modulo two of the OCC multiplexing factor is equal to the constant, and the constant is predefined.

Aspect 7: The method of Aspect 3, wherein the second integer multiple is two, and the slot index modulo two of the OCC multiplexing factor is equal to the constant, the method further comprising: receiving an indication of the constant.

Aspect 8: The method of any of Aspects 1-7, further comprising: receiving an indication of a scheduling delay offset in accordance with the OCC multiplexing factor, wherein transmitting the narrowband uplink communication at the time includes transmitting the narrowband uplink communication at the time in accordance with the scheduling delay offset.

Aspect 9: The method of Aspect 8, wherein the indication of the scheduling delay offset comprises downlink control information (DCI).

Aspect 10: The method of any of Aspects 1-14, further comprising: receiving, in accordance with the OCC multiplexing factor, an indication of an alignment offset that is equal to an integer value between zero and an integer multiple of the OCC multiplexing factor less one, inclusive, wherein transmitting the narrowband uplink communication at the time includes transmitting the narrowband uplink communication at the time in accordance with the alignment offset.

Aspect 11: The method of Aspect 10, wherein the integer multiple is one or two.

Aspect 12: The method of Aspect 11, wherein the integer multiple is one, and the indication of the alignment offset comprises downlink control information (DCI).

Aspect 13: The method of Aspect 11, wherein the integer multiple is one, and the indication of the alignment offset comprises an alignment offset index that corresponds to the alignment offset in accordance with a mapping.

Aspect 14: The method of Aspect 13, wherein the mapping is predefined.

Aspect 15: The method of Aspect 13, further comprising: receiving a radio resource control (RRC) configuration of the mapping.

Aspect 16: The method of Aspect 11, wherein the integer multiple is two, and the indication of the alignment offset comprises downlink control information (DCI).

Aspect 17: The method of Aspect 11, wherein the integer multiple is two, and the indication of the alignment offset comprises an alignment offset index that corresponds to the alignment offset in accordance with a mapping.

Aspect 18: The method of Aspect 17, wherein the mapping is predefined.

Aspect 19: The method of Aspect 17, further comprising: receiving a radio resource control (RRC) configuration of the mapping.

Aspect 20: A method of wireless communication performed by a network node, comprising: receiving a user equipment (UE) capability indication associated with multiplexing; transmitting, in accordance with the UE capability indication, an indication of an orthogonal cover code (OCC) multiplexing factor; and receiving a narrowband uplink communication at a time in accordance with the OCC multiplexing factor.

Aspect 21: The method of Aspect 20, wherein a slot index associated with the time is a first integer multiple of a second integer multiple of the OCC multiplexing factor, or the slot index modulo the second integer multiple of the OCC multiplexing factor is equal to a constant across UEs associated with the OCC multiplexing factor.

Aspect 22: The method of Aspect 21, wherein the second integer multiple is one or two.

Aspect 23: The method of Aspect 22, wherein the second integer multiple is one, the slot index modulo the OCC multiplexing factor is equal to the constant, and the constant is predefined.

Aspect 24: The method of Aspect 22, wherein the second integer multiple is one, and the slot index modulo the OCC multiplexing factor is equal to the constant, the method further comprising: transmitting an indication of the constant.

Aspect 25: The method of Aspect 22, wherein the second integer multiple is two, the slot index modulo two of the OCC multiplexing factor is equal to the constant, and the constant is predefined.

Aspect 26: The method of Aspect 22, the second integer multiple is two, and the slot index modulo two of the OCC multiplexing factor is equal to the constant, the method further comprising: transmitting an indication of the constant.

Aspect 27: The method of any of Aspects 20-26, further comprising: transmitting an indication of a scheduling delay offset in accordance with the OCC multiplexing factor, wherein receiving the narrowband uplink communication at the time includes receiving the narrowband uplink communication at the time in accordance with the scheduling delay offset.

Aspect 28: The method of Aspect 27, wherein the indication of the scheduling delay offset comprises downlink control information (DCI).

Aspect 29: The method of any of Aspects 20-28, further comprising: transmitting, in accordance with the OCC multiplexing factor, an indication of an alignment offset that is equal to an integer value between zero and an integer multiple of the OCC multiplexing factor less one, inclusive, wherein receiving the narrowband uplink communication at the time includes receiving the narrowband uplink communication at the time in accordance with the alignment offset.

Aspect 30: The method of Aspect 29, wherein the integer multiple is one or two.

Aspect 31: The method of Aspect 30, wherein the integer multiple is one, and the indication of the alignment offset comprises downlink control information (DCI).

Aspect 32: The method of Aspect 30, wherein the integer multiple is one, and the indication of the alignment offset comprises an alignment offset index that corresponds to the alignment offset in accordance with a mapping.

Aspect 33: The method of Aspect 32, wherein the mapping is predefined.

Aspect 34: The method of Aspect 32, further comprising: transmitting a radio resource control (RRC) configuration of the mapping.

Aspect 35: The method of Aspect 30, wherein the integer multiple is two, and the indication of the alignment offset comprises downlink control information (DCI).

Aspect 36: The method of Aspect 30, wherein the integer multiple is two, and the indication of the alignment offset comprises an alignment offset index that corresponds to the alignment offset in accordance with a mapping.

Aspect 37: The method of Aspect 36, wherein the mapping is predefined.

Aspect 38: The method of Aspect 36, further comprising: transmitting a radio resource control (RRC) configuration of the mapping.

Aspect 39: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-38.

Aspect 40: An apparatus for wireless communication at a device, the apparatus comprising one or more memories and one or more processors coupled to the one or more memories, the one or more processors configured to cause the device to perform the method of one or more of Aspects 1-38.

Aspect 41: An apparatus for wireless communication, the apparatus comprising at least one means for performing the method of one or more of Aspects 1-38.

Aspect 42: A non-transitory computer-readable medium storing code for wireless communication, the code comprising instructions executable by one or more processors to perform the method of one or more of Aspects 1-38.

Aspect 43: A non-transitory computer-readable medium storing a set of instructions for wireless communication, the set of instructions comprising one or more instructions that, when executed by one or more processors of a device, cause the device to perform the method of one or more of Aspects 1-38.

Aspect 44: A device for wireless communication, the device comprising a processing system that includes one or more processors and one or more memories coupled with the one or more processors, the processing system configured to cause the device to perform the method of one or more of Aspects 1-38.

Aspect 45: An apparatus for wireless communication at a device, the apparatus comprising one or more memories and one or more processors coupled to the one or more memories, the one or more processors individually or collectively configured to cause the device to perform the method of one or more of Aspects 1-38.

Aspect 46: A device comprising a processing system that includes one or more processors and one or more code-storing memories coupled with the one or more processors, the processing system configured to cause the device to perform the method of one or more of Aspects 1-38.

Aspect 47: A device comprising a processing system that includes processor circuitry and code-storing memory circuitry, the processing system configured to cause the device to perform the method of one or more of Aspects 1-38.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors coupled to the one or more memories, the one or more processors individually or collectively configured to cause the UE to:
transmit a UE capability indication associated with multiplexing;
receive, in accordance with the UE capability indication, an indication of an orthogonal cover code (OCC) multiplexing factor; and
transmit a narrowband uplink communication at a time in accordance with the OCC multiplexing factor.

2. The apparatus of claim 1, wherein a slot index associated with the time is a first integer multiple of a second integer multiple of the OCC multiplexing factor, or the slot index modulo the second integer multiple of the OCC multiplexing factor is equal to a constant across UEs associated with the OCC multiplexing factor.

3. The apparatus of claim 2, wherein the second integer multiple is one or two.

4. The apparatus of claim 3, wherein the second integer multiple is one, the slot index modulo the OCC multiplexing factor is equal to the constant, and the constant is predefined.

5. The apparatus of claim 3, wherein the second integer multiple is one, the slot index modulo the OCC multiplexing factor is equal to the constant, and the one or more processors are individually or collectively configured to cause the UE to:
receive an indication of the constant.

6. The apparatus of claim 3, wherein the second integer multiple is two, the slot index modulo two of the OCC multiplexing factor is equal to the constant, and the constant is predefined.

7. The apparatus of claim 3, wherein the second integer multiple is two, the slot index modulo two of the OCC multiplexing factor is equal to the constant, and the one or more processors are individually or collectively configured to cause the UE to:
receive an indication of the constant.

8. The apparatus of claim 1, wherein the one or more processors are individually or collectively configured to cause the UE to:
receive an indication of a scheduling delay offset in accordance with the OCC multiplexing factor, wherein the one or more processors configured to cause the UE to transmit the narrowband uplink communication at the time are configured to cause the UE to transmit the narrowband uplink communication at the time in accordance with the scheduling delay offset.

9. The apparatus of claim 8, wherein the indication of the scheduling delay offset comprises downlink control information (DCI).

10. The apparatus of claim 1, wherein the one or more processors are individually or collectively configured to cause the UE to:
receive, in accordance with the OCC multiplexing factor, an indication of an alignment offset that is equal to an integer value between zero and an integer multiple of the OCC multiplexing factor less one, inclusive, wherein the one or more processors configured to cause the UE to transmit the narrowband uplink communication at the time are configured to cause the UE to transmit the narrowband uplink communication at the time in accordance with the alignment offset.

11. The apparatus of claim 10, wherein the integer multiple is one or two.

12. The apparatus of claim 11, wherein the integer multiple is one, and the indication of the alignment offset comprises downlink control information (DCI).

13. The apparatus of claim 11, wherein the integer multiple is one, and the indication of the alignment offset comprises an alignment offset index that corresponds to the alignment offset in accordance with a mapping.

14. The apparatus of claim 13, wherein the mapping is predefined.

15. The apparatus of claim 13, wherein the one or more processors are individually or collectively configured to cause the UE to:
receive a radio resource control (RRC) configuration of the mapping.

16. The apparatus of claim 11, wherein the integer multiple is two, and the indication of the alignment offset comprises downlink control information (DCI).

17. The apparatus of claim 11, wherein the integer multiple is two, and the indication of the alignment offset comprises an alignment offset index that corresponds to the alignment offset in accordance with a mapping.

18. A method of wireless communication performed at a user equipment (UE), comprising:
transmitting a UE capability indication associated with multiplexing;
receiving, in accordance with the UE capability indication, an indication of an orthogonal cover code (OCC) multiplexing factor; and
transmitting a narrowband uplink communication at a time in accordance with the OCC multiplexing factor.

19. The method of claim 18, wherein a slot index associated with the time is a first integer multiple of a second integer multiple of the OCC multiplexing factor, or the slot index modulo the second integer multiple of the OCC multiplexing factor is equal to a constant across UEs associated with the OCC multiplexing factor.

20. An apparatus for wireless communication, comprising:
means for transmitting an apparatus capability indication associated with multiplexing;
means for receiving, in accordance with the apparatus capability indication, an indication of an orthogonal cover code (OCC) multiplexing factor; and
means for transmitting a narrowband uplink communication at a time in accordance with the OCC multiplexing factor.
